(19) United States
(12) Patent Application Publication
(10) Pub. No.: US 2013/0177169 A1
(43) Pub. Date: Jul. 11, 2013

(54) SPEAKER SYSTEM

(71) Applicant: TEI CO., LTD., Tokyo (JP)

(72) Inventor: Hitoshi KANAYA, Tokyo (JP)

(73) Assignee: TEI CO., LTD., Tokyo (JP)

(21) Appl. No.: 13/714,131

(22) Filed: Dec. 13, 2012

(30) Foreign Application Priority Data
Dec. 15, 2011 (JP) 2011-274872
Nov. 30, 2012 (JP) 2012-262511

(51) Int. Cl. H04R 1/32

(52) U.S. Cl. CPC H04R 1/323
USPC 381/97

(57) ABSTRACT

Speaker systems having simple structure, high output power, and desired directivity are disclosed. In one embodiment, a speaker system includes a first sound emission surface that emits a first sound in a first direction and a second sound emission surface that emits a second sound in a second direction that intersects with the first direction at a predetermined angle. The first and second sounds include at least sounds respectively generated from a common first signal source and different in phase from each other.

### CROSS REFERENCE TO RELATED APPLICATIONS

This application claims the benefit of priority from Japanese Patent Application No. 2011-274872, filed on 15 Dec. 2011, and Japanese Patent Application No. 2012-262511, filed on 30 Nov. 2012, the disclosures of which are incorporated herein in their entireties.

### BACKGROUND

1. Technical Field

The present invention relates to a speaker system.

2. Description of the Related Art

As a speaker system for emitting a sound to a space in accordance with an input signal, there is conventionally known a speaker system including one or more speaker units. The speaker unit constituting the speaker system includes, for example, a speaker, a speaker box that supports the speaker, and an outer casing. The speaker is provided with a vibrating member that is formed with a sound emission surface for emitting a sound, and an actuator that drives the vibrating member. The actuator drives the vibrating member in accordance with an input signal to emit a sound. The speaker may include, for example, a conical type diaphragm or a flat type diaphragm as a diaphragm thereof.

A speaker including a conical type diaphragm is operable to emit a sound from a conical shaped emission surface formed on the diaphragm. This type of a speaker includes, for example, a conical shaped diaphragm, a frame, and a voice coil type actuator. The diaphragm is deformable in an out-of-plane direction. The voice coil type actuator is adapted to vibrate the diaphragm in the out-of-plane direction and emit a sound from a surface of the diaphragm when an alternating voltage is applied to a voice coil positioned within a magnetic gap.

On the other hand, a speaker including a flat type diaphragm emits a sound from a flat type emission surface formed on the diaphragm. This type of a speaker includes, for example, a flat shaped diaphragm, an edge, a frame that supports the diaphragm via the edge, a voice coil that is positioned within a magnetic gap, and a voice coil type actuator. The voice coil type actuator is adapted to vibrate the diaphragm in the out-of-plane direction and emit a sound from a surface of the diaphragm when an alternating voltage is applied to the voice coil.

According to a speaker system, in which the above described speaker units are arrayed in a plural number, it is possible to obtain a high output with a simple configuration. Meanwhile, every single speaker unit has a unique directivity pattern of sound emission, and a speaker system including a plurality of speaker units as well has a unique sound directivity pattern of sound emission. In order to control such directivity patterns, various speaker units or speaker systems have been heretofore developed.

For example, Japanese Unexamined Patent Application, Publication No. H07-131893 discloses a speaker unit such that one single magnetic circuit simultaneously drives diaphragms provided on both sides of the magnetic circuit to emit in phase sounds from the both sides respectively, thereby realizing bidirectional directivity.

Japanese Unexamined Patent Application, Publication No. 2009-21657 discloses a technology such that delay circuits are used to shift in phase input signals to a plurality of speakers, thereby controlling the directivity of the speaker system. Also, Japanese Unexamined Patent Application, Publication No. 2009-81613 and Japanese Unexamined Patent Application, Publication No. 2011-9990 disclose technologies such that microphones are employed to pick up sounds emitted from a plurality of speakers and feed back information for controlling the directivity of the speaker system.

However, the conventional speaker system, in which a plurality of speaker units are arranged, suffers from a drawback in that the directivity cannot be controlled properly. As a result of this, problems may occur such that sounds excessively concentrate in a specific space, or conversely, sounds diffuse so much and cannot be heard clearly due to reflection.

A primary purpose of employing a plurality of speaker units is to deliver a high power sound to a wide area. However, if each speaker unit outputs a sound at high volume, the sounds excessively concentrate in front of the speaker system and become too loud. Therefore, each speaker unit had to output a sound at a relatively low volume, and a large number of speaker units had to be arranged one after another at a distance of several meters, thereby increasing production cost.

Furthermore, there has been an attempt to employ a bidirectional speaker, which emits sounds merely at both sides so as to deliver sounds in a wide area. However, in the front area, the sounds interfere with one another in an unrestricted manner, and cause various problems.

According to some embodiments of the present invention, in an environment, in which the sounds are reflected from the surroundings, it is preferable that the sounds directly delivered from the speaker toward a front area are suppressed to a sound pressure level of zero so as to form a valley area of the directivity pattern in the front area. Since the reflected sounds are delivered even in an area where the sound pressure level is zero, sounds can be heard in the front area. On the other hand, if the sound is not suppressed to a sound pressure level of zero in the front area, the sounds interfere with one another in an unrestricted manner, and cause various problems.

For example, the speaker unit disclosed in Japanese Unexamined Patent Application, Publication No. H07-131893 cannot suppress the sound to a pressure level of zero in a middle area between both speakers by simply directing the two speakers toward both sides, and thus cannot form a complete bidirectional directivity pattern.

For example, a case is assumed in which a speaker system having such an incomplete bidirectional directivity pattern is installed in a narrow space, for example, in a ceiling of a tunnel. In such a case, in the area immediately below the speaker system, a sound directly but weakly emitted from the speaker system is interfered with sounds complexly reflected from surrounding walls in an unrestricted manner. The direct sound and the reflected sounds are greatly different from one another in propagation distance. Accordingly, the direct sound and the reflected sounds greatly differ from one another in phase depending on a location. As a result thereof, such problems occur that the sound is heard very loudly, noisy, hardly audible, or the like depending on the location.

Furthermore, any one of the conventional speaker systems disclosed in, for example, Japanese Unexamined Patent Application, Publication No. H07-131893, Japanese Unexamined Patent Application, Publication No. 2009-21657, Japanese Unexamined Patent Application, Publication No. 2009-81613, and Japanese Unexamined Patent Application, Publication No. 2011-9990 is required to control a plurality of speakers in a complex manner, thus a complex configuration is needed.

Such problems cannot be solved even if the directions of speakers are changed from each other.

FIG. 18A is an explanatory drawing of sound directivity of a speaker system 500 of prior art in which speaker units 501 and 502 of prior art are combined. The speaker units 501 and 502 are respectively facing toward a first direction K1 and a second direction K2. As shown in FIG. 18A, in a space region R3 defined between the first and second directions K1 and K2 in front of the speaker units 501 and 502, the sounds respectively emitted from the speaker units 501 and 502 interfere with each other. As a result thereof, the above-described problems occur that the sound is heard very loudly, noisy, hardly audible, or the like depending on the location.

FIG. 18B is aside view of a propagation direction of the sound emitted from a speaker system of prior art installed in the similar space. FIG. 18C is a top view of the sound directivity of the speaker system of prior art installed in a space such as tunnel in a similar manner to FIG. 18B. As will be seen in the FIGS. 18B and 18C, in the case of the speaker system of prior art, for example, in an area where the direct sounds and the sounds reflected from the wall overlap with each other, sounds are diffused in an unrestricted manner and excessively reflected from walls, thereby making the sound unclear approximately everywhere.

Another problem is encountered in that a sound reaches an area where the sound is not desired to reach. For example, if sounds reach a wall surface, which the sounds are not desired to reach, a sound reflected by the wall surface may cause excessive reflections and makes the sounds unclear. Thus, in order to appropriately control the reflected sound, a technology is needed that can control directivity as desired.

In view of the above described problems, embodiments of the present invention provide a speaker system having simple structure, high output power, and desired directivity.

### SUMMARY

In order to attain the above described object, according to one aspect of the present invention, there is provided a speaker system including a first sound emission surface that emits a first sound in a first direction, and a second sound emission surface that emits a second sound in a second direction that intersects with the first direction at a predetermined angle. The first and second sounds include at least respective sounds generated from a common first signal source and different in phase from each other.

According to the above described configuration, the speaker system according to some embodiments of the present invention includes the first sound emission surface that emits the first sound in the first direction, and the second sound emission surface that emits the second sound in the second direction. The first and second directions intersect with each other at the predetermined angle. The first and second sounds include at least respective sounds generated from the common first signal source and different in phase from each other. Therefore, it becomes possible to implement a speaker system having specific directivity due to interference between sounds that are different from but associated with each other. Furthermore, since the sounds from the first and second sound emission surfaces are added together, it becomes possible to obtain a high output with a simple configuration. Thus, a speaker system is provided that has simple structure, high output power, and desired directivity.

According to some embodiments of the present invention, in the speaker system as described above, the first and second sounds may be generated from a common signal source and different in phase from each other. For example, the first and second sounds may be generated from a common signal by processing in different ways to be opposite in phase to each other. According to this configuration, it becomes possible to configure so that the sounds may be inaudible in a space region where the sounds interfere with and cancel out each other, and that the sounds may be audible in a space region having no sound cancellation.

According to some embodiments of the present invention, in the speaker system as described above, the first and second sounds may further include at least respective sounds generated from a common second signal source and identical in phase to each other. According to this configuration, it becomes possible to configure so that, among the first and second sounds, sounds reverse in phase to each other generated from the first signal source are inaudible but mutually in-phase sounds generated from the second signal source are audible in a space region where sounds reverse in phase to each other cancel each other out, and that sounds generated from the first and second signal sources are audible as they are in a space region having no sound cancellation.

According to some embodiments of the present invention, the speaker system as described above may further include a third sound emission surface that emits a third sound in a third direction that intersects with the first and second directions respectively at predetermined angles. The third sound may include at least a sound generated from the common first signal source. According to this configuration, it becomes possible to emit the sound from the common first signal source in the third direction as well as the first and second directions. Therefore, it becomes possible to emit sounds in multiple directions and create a plurality of regions where sounds outputted from respective speaker units affect one another.

According to some embodiments of the present invention, the signal source is not limited to a signal indicative of a “meaningful sound” such as background music, but an output signal from a noise cancelling device for cancelling a surrounding noise may be employed. For example, as the signal for cancelling a noise, a signal for generating a sound, which is shifted in phase by 180 degrees from the surrounding noise, may be employed. Especially, in a case in which particular noise is specified such as ambulance siren, tunnel noise, highway noise and/or the like, a signal for generating a sound, which is shifted in phase by 180 degrees from the particular sound pattern thereof, may be employed as the signal for cancelling the noise.

More specifically, the first and second sounds may include a sound, which is generated from the second signal source and shifted in phase by 180 degrees from noise.

According to some embodiments of the present invention, the speaker system as described above is provided with a first speaker group and a second speaker group. The first speaker group may include one or more first speaker units arrayed in one or more lines including a plurality of speaker units arrayed along an imaginary line that extends perpendicular to the first and second directions. The second speaker group may include one or more second speaker units arrayed in one or more lines including a plurality of speaker units arrayed along the imaginary line.

According to this configuration, the first speaker group includes the first speaker units arrayed in one or more lines including the plurality of speaker units arrayed along the imaginary line, and the second speaker group includes the second speaker units arrayed in one or more lines including the plurality of speaker units arrayed along the imaginary line. Therefore, it becomes possible to generate a high power sound by overlapping the sounds emitted from the sound emission surfaces. While a single speaker unit, being a point sound source, emits a sound as a spherical wave, the speaker units arrayed in one or more lines including the plurality of speaker units arrayed along the imaginary line, being a line sound source, emits a sound as a cylindrical wave, which has less attenuation with distance. Therefore, it becomes possible to deliver a sound to a long distance with a sharp directivity.

According to some embodiments of the present invention, each speaker unit constituting the first and second speaker groups includes a speaker and a speaker box that supports the speaker. The speaker includes a vibrating member formed with the sound emission surface on a front surface thereof and an actuator that drives the vibrating member. The vibrating member is formed with the sound emission surface of an elongated outline. In the first speaker group, the plurality of speaker units may be arranged so that respective longitudinal directions of the outlines thereof are parallel to one another and the first sound emission surfaces thereof form the same plane. In the second speaker group, the plurality of speaker units may be arranged so that respective longitudinal directions of the outlines thereof are parallel to one another and the second sound emission surfaces thereof form the same plane.

According to this configuration, in the first speaker group of the speaker system as described above, the plurality of speaker units are arranged so that respective longitudinal directions of the outlines thereof are parallel to one another and the first sound emission surfaces thereof form the same plane. In the second speaker group of the speaker system, the plurality of speaker units are arranged so that respective longitudinal directions of the outlines thereof are parallel to one another and the second sound emission surfaces thereof form the same plane. Therefore, the sound emission surfaces are close to one another, and the respective sounds from the sound emission surfaces can efficiently overlap and become loud.

Furthermore, according to some embodiments of the present invention, each speaker unit constituting the first and second speaker groups includes a speaker and a speaker box that supports the speaker. The speaker includes a vibrating member formed with the sound emission surface on a front surface thereof and an actuator that drives the vibrating member. The vibrating member is formed with the sound emission surface having an outline including at least one pair of parallel sides. In the first speaker group, the plurality of speaker units may be arranged so that the at least one pair of parallel sides of the outline of each vibrating member are parallel to the at least one pair of parallel sides of the outline of every other vibrating member, and the first sound emission surfaces thereof form the same plane. In the second speaker group, the plurality of speaker units may be arranged so that the at least one pair of parallel sides of the outline of each vibrating member are parallel to the at least one pair of parallel sides of the outline of every other vibrating member, and the second sound emission surfaces thereof form the same plane.

According to this configuration, in the first speaker group of the speaker system as described above, the plurality of speaker units are arranged so that the at least one pairs of parallel sides of the outlines thereof are parallel to one another, and the first sound emission surfaces thereof form the same plane. In the second speaker group of the speaker system, the plurality of speaker units are arranged so that the at least one pairs of parallel sides of the outlines thereof are parallel to one another, and the second sound emission surfaces thereof form the same plane. Therefore, the sound emission surfaces can be close to one another, the sounds from the sound emission surfaces can efficiently overlap and become loud.

According to the present embodiment, in the above described speaker system, viewed from a direction that bisects the angle formed between the first and second directions, a central part of the first sound emission surface may be positioned on a side of the first direction from an intermediate position between the first and second sound emission surfaces. Similarly, a central part of the second sound emission surface may be positioned on a side of the second direction from an intermediate position between the first and second sound emission surfaces.

According to this configuration, in the above described speaker system, viewed from the direction that bisects the angle formed between the first and second directions, the central part of the first sound emission surface is positioned on the side of the first direction from an intermediate position between the first and second sound emission surfaces. Similarly, the central part of the second sound emission surface is positioned on the side of the second direction from an intermediate position between the first and second sound emission surfaces. Therefore, sounds respectively emitted from the first and second sound emission surfaces can efficiently interfere with each other in a space between the first and second directions.

According to some embodiments of the present invention, in the above described speaker system, viewed from the direction that bisects the angle formed between the first and second directions, a first end portion, which is defined as an end portion of the outline of the first sound emission surface on a side of the second sound emission surface, and a second end portion, which is defined as an end portion of the outline of the second sound emission surface on a side of the first sound emission surface, may be adjacent to each other.

According to this configuration, in the above described speaker system, the first end portion, which is defined as the end portion of the outline of the first sound emission surface on the side of the second sound emission surface, and the second end portion, which is defined as the end portion of the outline of the second sound emission surface on the side of the first sound emission surface, are adjacent to each other. Therefore, sounds respectively emitted from the first and second sound emission surfaces can efficiently interfere with each other in the space between the first and second directions.

According to some embodiments of the present invention, in the above described speaker system, the first speaker units arrayed in one or more lines and the second speaker units arrayed in one or more lines may be staggered with each other. According to this configuration, the first speaker units arrayed in one or more lines and the second speaker units arrayed in one or more lines are arranged in staggered relation to each other. Therefore, the sounds emitted from the first and second speaker units respectively arrayed in one or more lines can efficiently interfere and overlap with each other.

According to some embodiments of the present invention, in the above described speaker system, the first speaker units arrayed in one or more lines and the second speaker units arrayed in one or more lines may be arrayed equidistantly with a constant pitch along the imaginary line. According to this configuration, the first speaker units arrayed in one or more lines and the second speaker units arrayed in one or more lines are arrayed equidistantly with the constant pitch along the imaginary line. Therefore, the sounds emitted from the first and second speaker units respectively arrayed in one or more lines can uniformly interfere and overlap with each other.

According to some embodiments of the present invention, the intersection angle of the first and second directions may be in a range between 45 and 135 degrees. According to this configuration, it becomes possible to obtain a directivity property in accordance with the intersection angle of the first and second directions.

Furthermore, according to some embodiments of the present invention, the intersection angle of the first and second directions may be variable. According to this configuration, as a result thereof, it becomes possible to change the directivity property in accordance with the intersection angle of the first and second directions.

In the speaker system according to one embodiment of the present invention, the first speaker group includes one or more first speaker units including one or more speaker units arrayed in series along the imaginary line, and the second speaker group includes one or more second speaker units including one or more speaker units arrayed in series along the imaginary line. The speaker of the speaker unit includes a vibrating member, a frame, an edge, and an actuator. The vibrating member may be a member formed of a planar front surface and include a vibrating member outer peripheral part formed with an outline in which a pair of straight lines and a pair of flexure lines are alternatingly connected. The frame is provided with a frame opening part surrounding by a frame inner peripheral part formed with an outline in which a pair of straight lines and a pair of flexure lines are alternatingly connected. The edge is an annular elastic member including an edge outer peripheral part that is an outer peripheral part thereof and an edge inner peripheral part that is an inner peripheral part thereof, the edge outer peripheral part being fixed to the frame inner peripheral part, and the edge inner peripheral part being fixed to the vibrating member outer peripheral part. The actuator is supported by the frame and drives the vibrating member to vibrate in the out-of-plane direction. The flexure line is a polygonal line, a curved line, or a combination of one or more polygonal lines and one or more curved lines. The vibrating member fits in the frame opening part in such a manner that the vibrating member outer peripheral part may not contact the frame inner peripheral part. A gap between the respective flexure lines of the vibrating member outer peripheral part and the frame inner peripheral part may be wider than a gap between the respective straight lines of the vibrating member outer peripheral part and the frame inner peripheral part.

According to the configuration of the above described embodiment, the one or more first speaker units of the first speaker group are arrayed in series along the imaginary line, and the one or more second speaker units of the second speaker group are arrayed in series along the imaginary line. The vibrating member is configured by a plate including the vibrating member outer peripheral part that is an outer peripheral part formed with an outline of a pair of straight lines and a pair of flexure lines alternatingly connected.

The frame may be provided with a frame opening part that is an opening part surrounded by a frame inner peripheral part that is an inner peripheral part formed with an outline of a pair of straight lines and a pair of flexure lines alternatingly connected. The edge may be an annular elastic member including an edge outer peripheral part that is an outer peripheral part thereof, and an edge inner peripheral part that is an inner peripheral part thereof. The edge outer peripheral part may be fixed to the frame inner peripheral part, and the edge inner peripheral part may be fixed to the vibrating member outer peripheral part.

The actuator is supported by the frame and drives the vibrating member to vibrate in the out-of-plane direction. The vibrating member fits in the frame opening part in such a manner that the vibrating member outer peripheral part may not contact the frame inner peripheral part. A gap between the respective flexure lines of the vibrating member outer peripheral part and the frame inner peripheral part may be wider than a gap between the respective straight lines of the vibrating member outer peripheral part and the frame inner peripheral part.

According to this configuration, it becomes easily possible for the edge to have similar bending stiffness both along the straight lines and along the flexure lines, which enables the vibrating member to uniformly vibrate in the out-of-plane direction and the sound emission surface to emit a uniform sound to be precisely overlapped and reinforced.

In the speaker system according to one embodiment of the present invention, a gap between respective straight lines of the vibrating member outer peripheral part and the frame inner peripheral part may have a predetermined width, and a gap between respective flexure lines of the vibrating member outer peripheral part and the frame inner peripheral part may become wider from the both ends of the flexure line toward the middle thereof.

According to the configuration described above, the gap between respective straight lines of the vibrating member outer peripheral part and the frame inner peripheral part has the predetermined width. The gap between respective flexure lines of the vibrating member outer peripheral part and the frame inner peripheral part becomes wider from the both ends of the flexure line toward the middle thereof.

According to this configuration, it becomes easily possible for the edge to have similar bending stiffness both along the straight lines and along the flexure lines, which enables the vibrating member to uniformly vibrate in the out-of-plane direction and the sound emission surface to emit a uniform sound to be precisely overlapped and reinforced.

In the speaker system according to one embodiment of the present invention, defining a flexure line as a curved line having a predetermined curvature radius, the flexure line of the frame inner peripheral part may smoothly connect the pair of straight lines thereof, the flexure line of the vibrating member outer peripheral part may smoothly connect the pair of straight lines thereof, and the center of curvature of the curved line of the vibrating member outer peripheral part may be located more inside than that of the curved line of the frame inner peripheral part.

According to the configuration described above, defining a flexure line as a curved line having a predetermined curvature radius, the flexure line of the frame inner peripheral part smoothly connects the pair of straight lines thereof, the flexure line of the vibrating member outer peripheral part smoothly connects the pair of straight lines thereof, and the center of curvature of the curved line of the vibrating member outer peripheral part is located more inside than that of the curved line of the frame inner peripheral part. As a result thereof, the gap between flexure lines becomes wider from the both ends respectively connected to the straight lines toward the middle thereof.

In a speaker system according to one embodiment of the present invention, the frame may include a sub frame formed with the frame opening part and a main frame that fixes the sub frame and supports the actuator. The sub frame may be a plate-like member. The edge may include a front edge and a rear edge. An outer peripheral part of the front edge may be fixed to a front surface of the frame inner peripheral part, and an inner peripheral part of the front edge may be fixed to a front surface of the vibrating member outer peripheral part. An outer peripheral part of the rear edge may be fixed to a rear surface of the frame inner peripheral part, and an inner peripheral part of the rear edge may be fixed to a rear surface of the vibrating member outer peripheral part. The sub frame may be fixed to the main frame so that the front edge and the rear edge may not be fixed to the main frame.

According to the above described configuration, the frame includes a sub frame formed with the frame opening part and a main frame that fixes the sub frame and supports the actuator. The sub frame is a plate-like member. The edge includes a front edge and a rear edge. An outer peripheral part of the front edge is fixed to a front surface of the frame inner peripheral part, and an inner peripheral part of the front edge is fixed to a front surface of the vibrating member outer peripheral part. An outer peripheral part of the rear edge is fixed to a rear surface of the frame inner peripheral part, and an inner peripheral part of the rear edge is fixed to a rear surface of the vibrating member outer peripheral part. The sub frame is fixed to the main frame so that the front edge and the rear edge may not be fixed to the main frame. As a result thereof, it becomes possible to efficiently suppress tilt of the vibrating member owing to tensile stiffness of the elastic member constituting the edge.

In the speaker system according to one embodiment of the present invention, the speaker may be provided with a cover frame that covers an outer peripheral part and a side surface of the sub frame. The sub frame may be lower in elastic modulus than the cover frame. According to the above described configuration of the embodiment, the cover frame covers the outer peripheral part and the side surface of the sub frame, and the sub frame is lower in elastic modulus than the cover frame. As a result thereof, it becomes possible to enhance overall stiffness of the speaker unit, and maintain low stiffness of a structure that supports the vibrating member.

In the speaker system according to one embodiment of the present invention, the actuator may include a voice coil bobbin that is fixed to the vibrating member, a voice coil that is wound around the voice coil bobbin, a yoke that is made of magnetic material and fixed to the main frame, a magnet that is fixed to the yoke, a pole piece that is made of magnetic material and fixed to the magnet, and an auxiliary magnet that is fixed to the pole piece. The voice coil may be positioned within a magnetic gap formed between the yoke and the pole piece so as to transmit a force perpendicular to the surface of the vibrating member from a magnetic field generated in the magnetic gap.

According to the above described configuration, the actuator includes the voice coil bobbin that is fixed to the vibrating member, the voice coil that is wound around the voice coil bobbin, the yoke that is made of magnetic material and fixed to the main frame, the magnet that is fixed to the yoke, the pole piece that is made of magnetic material and fixed to the magnet, and the auxiliary magnet that is fixed to the pole piece. The voice coil is positioned within a magnetic gap formed between the yoke and the pole piece and transmits a force perpendicular to the surface of the vibrating member from a magnetic field generated in the magnetic gap. As a result thereof, it becomes possible to suppress tilt of the vibrating member.

To provide a speaker system having simple structure, high output power, and desired directivity.

### BRIEF DESCRIPTION OF THE DRAWINGS

Systems and methods that embody the various features of the invention will now be described with reference to the following drawings, in which:

FIG. 1 is a schematic explanatory view of a speaker system according to a first embodiment of the present invention;

FIG. 2 is a schematic view and a front view of the speaker system according to the first embodiment of the present invention;

FIG. 3 is a cross sectional view of the speaker system according to the first embodiment of the present invention;

FIG. 4 is a cross sectional view of a speaker unit constituting the speaker system according to the first embodiment of the present invention and a diagram showing one example of a sound emission surface thereof;

FIG. 5 is a graph showing a directivity pattern of the speaker system according to the first embodiment of the present invention;

FIG. 6 is a drawing showing one exemplary application of the speaker system according to the first embodiment of the present invention;

FIG. 7 is a schematic view and a front view of a speaker system according to a second embodiment of the present invention;

FIG. 8 is a cross sectional view of the speaker system according to the second embodiment of the present invention;

FIG. 9 is a cross sectional view of a speaker system according to a third embodiment of the present invention;

FIG. 10 is a cross sectional view of a speaker unit constituting the speaker system according to the third embodiment of the present invention and a diagram showing one example of a sound emission surface thereof;

FIG. 11 is a cross sectional view of a speaker system according to a fourth embodiment of the present invention;

FIG. 12 is a diagram showing a directivity pattern of the speaker system according to the fourth embodiment of the present invention;

FIG. 13 is an explanatory perspective view of the speaker system according to the fourth embodiment of the present invention;

FIGS. 14A, 14B, 14C, and 14D are a set of diagram respectively showing a sound emission surface of a speaker unit applicable to the speaker system according to some embodiments of the present invention;

FIGS. 15A and 15B are a set of diagrams explaining directivity of the speaker system according to some embodiments of the present invention;

FIGS. 16A and 16B are a set of diagrams explaining directivity of the speaker system according to some embodiments of the present invention;

FIG. 17 is a diagram explaining bidirectional directivity of the speaker system according to some embodiments of the present invention; and

FIGS. 18A, 18B, and 18C are a set of diagrams illustrating directivity of a speaker system of prior art.

### DETAILED DESCRIPTION

In the following, a description will be given of embodiments of the present invention with reference to drawings. In all embodiments of the present specification, similar constituent elements are denoted by the same symbols.

While certain embodiments are described, these embodiments are presented by way of example only, and are not intended to limit the scope of protection. Indeed, the novel methods and systems described herein may be embodied in a variety of other forms. Furthermore, various omissions, substitutions, and changes in the form of the methods and systems described herein may be made without departing from the scope of protection.

### First Embodiment

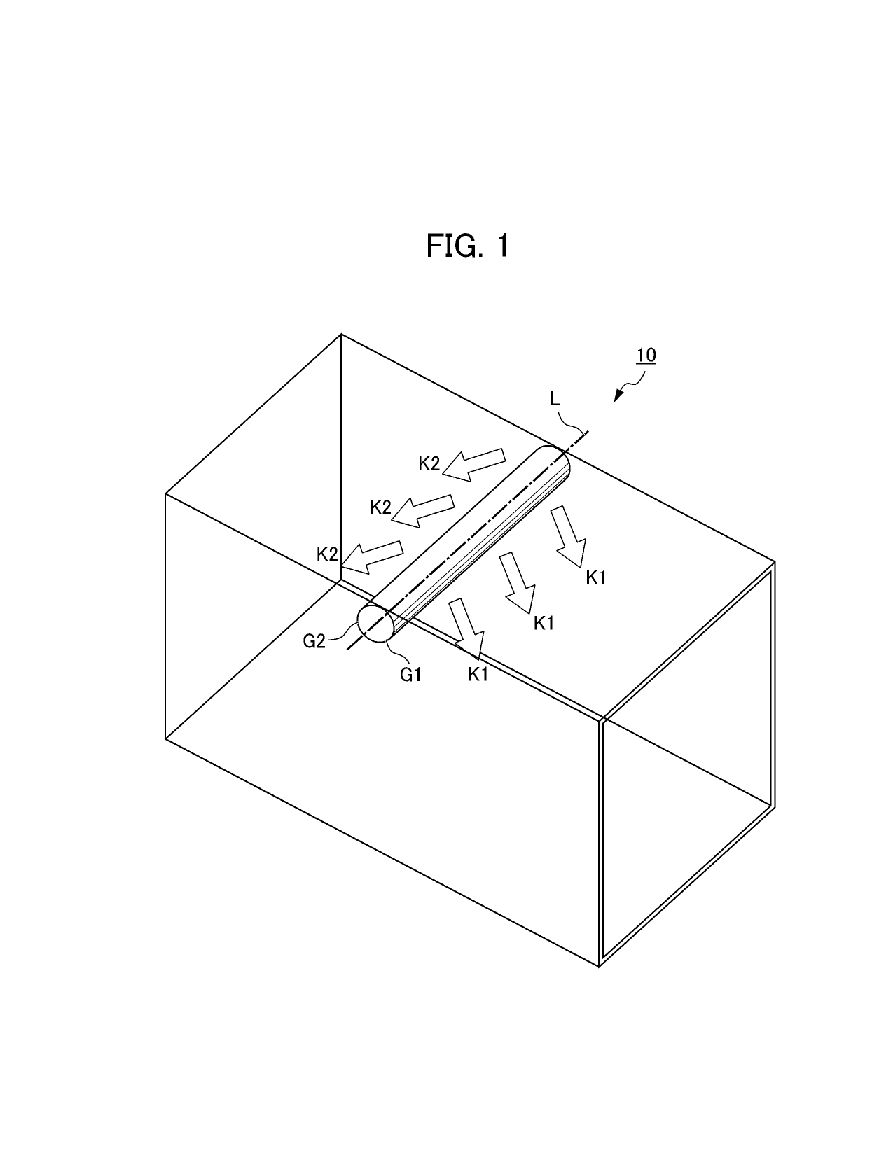

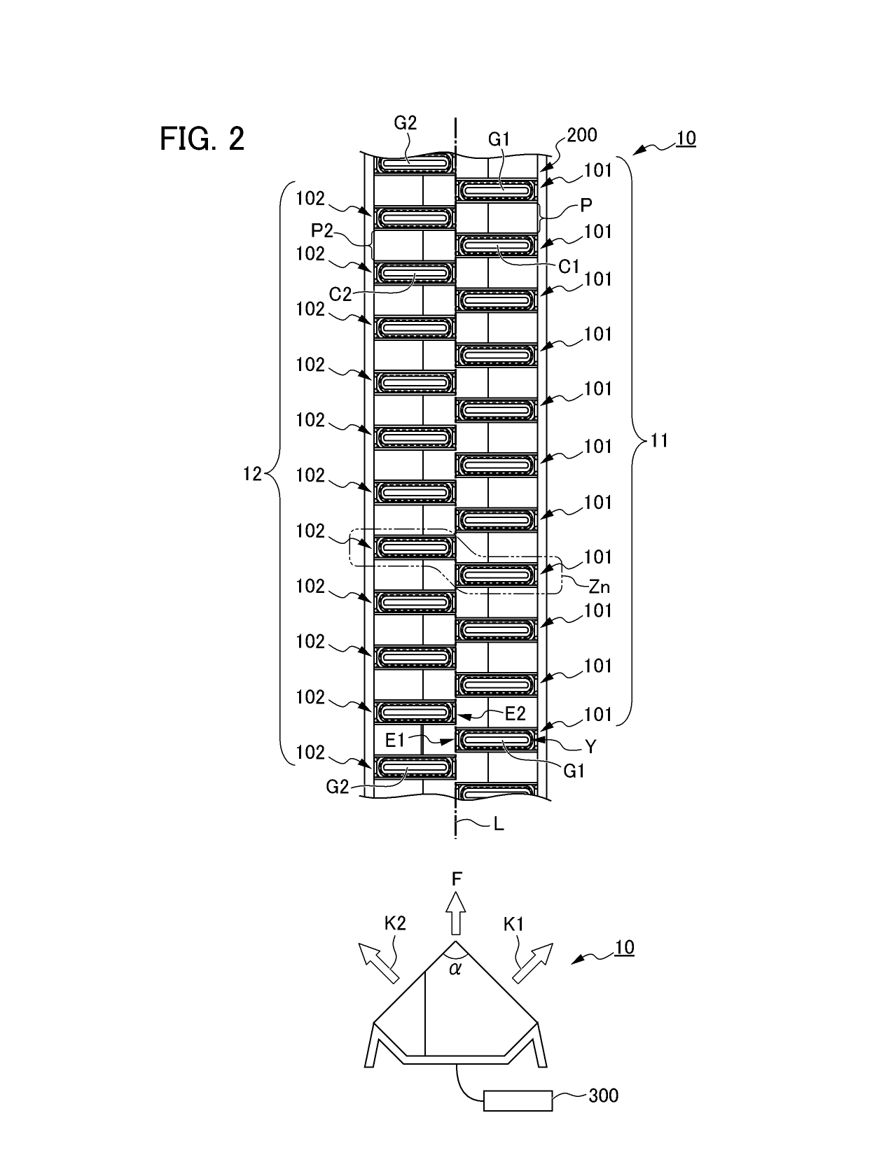

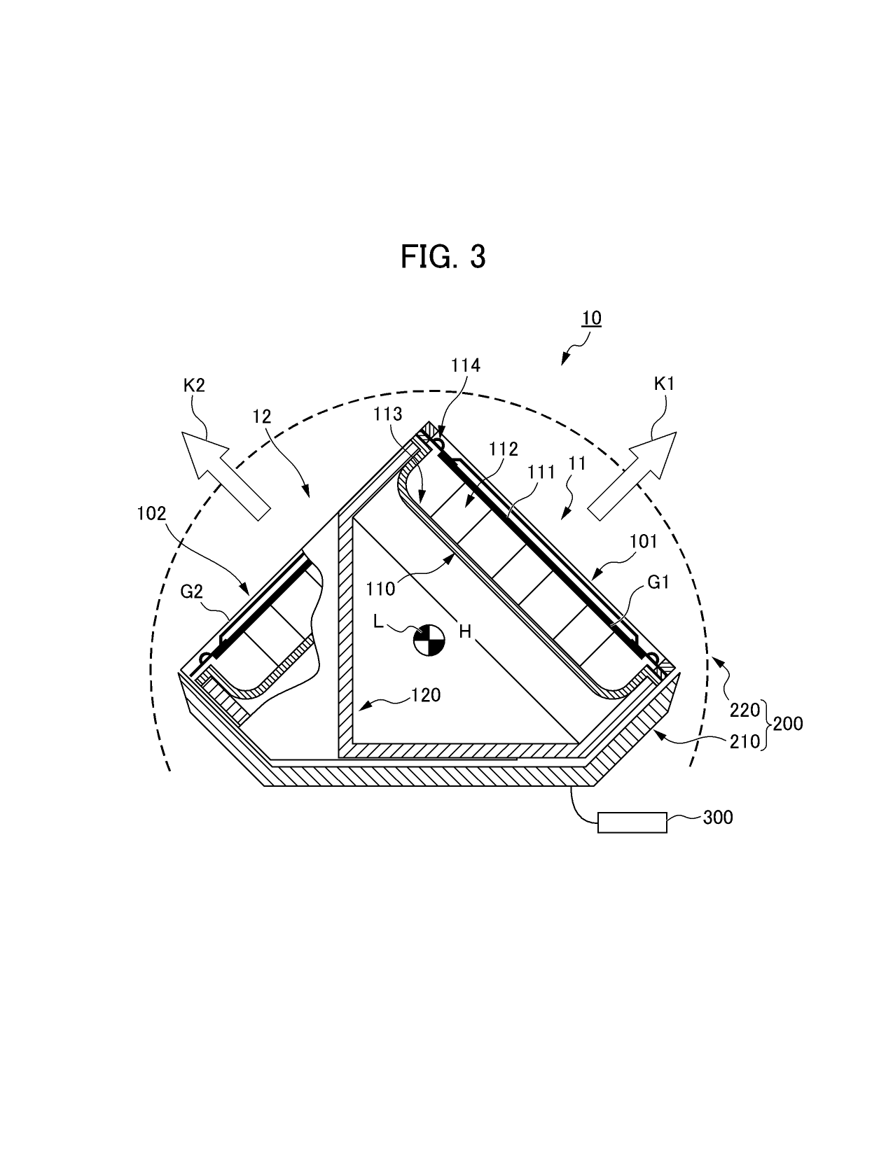

The following description is directed to a speaker system 10 according to a first embodiment of the present invention with reference to drawings. FIG. 1 is a schematic explanatory view of the speaker system 10 assuming that the speaker system 10 is installed in an elongated cavity space such as an underground passage. FIG. 2 is a schematic view and a front view of the speaker system 10. FIG. 3 is a cross sectional view of the speaker system 10.

As shown in FIG. 1, the speaker system 10 according to the first embodiment of the present invention is adapted to emit sounds in two directions, i.e., a first direction K1 and a second direction K2.

As shown in FIG. 2, the speaker system 10 is provided with a first speaker group 11 including a plurality of speaker units 101 each having a first sound emission surface G1, a second speaker group 12 including a plurality of speaker units 102 each having a second sound emission surface G2, and a signal input unit 300 that inputs acoustic signals to the first and second speaker groups 11 and 12.

The first speaker group 11 emits a sound from the first sound emission surfaces G1 in accordance with a first input inputted to the speaker system 10 from the signal input unit 300. The second speaker group 12 emits a sound from the second sound emission surfaces G2 in accordance with a second input inputted to the speaker system 10 from the signal input unit 300.

As shown in the front view of FIG. 2, the first speaker group 11 is configured such that a plurality of the first speaker units 101 are arrayed in one line along an imaginary line L, which will be described later. Similarly, the second speaker group 12 is configured such that a plurality of the second speaker units 102 are arrayed in one line along the imaginary line L.

In FIG. 2, sound emission surfaces of the first and second speaker units at the bottom are respectively referred to as the first sound emission surface G1 and the second sound emission surface G2. Here, however, the overall sound emission surfaces G1 of the plurality of first speaker units 101 constituting the first speaker group 11 will also be inclusively referred to as the “first sound emission surface G1”, and the overall sound emission surfaces G2 of the plurality of second speaker units 102 constituting the second speaker group 12 will also be inclusively referred to as the “second sound emission surface G2”.

Here, the imaginary line L is defined as a line extended through approximately central part of the speaker system 10 according to some embodiments of the present invention along a direction in which the plurality of first speaker units 101 are arrayed and in which the plurality of second speaker units 102 are arrayed.

The first direction K1 is defined as an approximately normal direction of the first sound emission surface G1 toward which the first sound emission surface G1 faces, and the second direction K2 is defined as an approximately normal direction of the second sound emission surface G2 toward which the second sound emission surface G2 faces. Therefore, the first and second directions K1 and K2 are perpendicular to the imaginary line L.

Furthermore, a front direction F of the speaker system 10 is defined as a bisecting direction of an angle formed between the first direction K1 and the second direction K2.

Furthermore, an intersection angle α is defined as a predetermined salient angle formed between the first and second directions K1 and K2. This means that the intersection angle α is an angle by which the first and second directions K1 and K2 intersect with each other having the front direction F in between.

In the present embodiment, it is assumed that the intersection angle α is constant and rectangular.

Although the imaginary line L is expressed as a straight line in FIG. 2, the imaginary line L may be a curved line. This means that embodiments of the present invention are applicable even if the speaker system 10 is provided with a plurality of first speaker units 101 and a plurality of second speaker units 102 arrayed along a curved imaginary line L.

The first and second directions K1 and K2 may be variable along the imaginary line L as long as the above described intersection angle α maintains to be bisected by the front direction F. In the case of changing the first and second directions K1 and K2 depending on location on the imaginary line L, it is preferable that, for each of the first speaker units 101, an appropriate one of the second speaker units 102 that is closest to the first speaker unit 101 is selected from among the second speaker units 102, and paired with the first speaker unit 101, and the directions K1 and K2 are changed for each pair, accordingly.

As shown in FIG. 2, the speaker system 10 includes the plurality of first and second speaker units 101 and 102, and an outer casing 200. More particularly, the speaker system 10 is configured by the first speaker group 11 including the plurality of first speaker units 101, the second speaker group 12 including the plurality of second speaker units 102, and the outer casing 200.

In FIG. 2, it has been assumed that the first and second speaker groups 11 and 12 respectively include the plurality of first speaker units 101 and the plurality of second speaker units 102. However, there is no limitation thereto, and the first and second speaker groups 11 and 12 may respectively include a single speaker unit 101 and a single speaker unit 102.

Although, in the speaker system 10 of the present embodiment, the first speaker group 11 includes the plurality of first speaker units 101 arrayed in one line, the first speaker units 101 may be arrayed in a plurality of lines. The same is applied to the second speaker group 12.

Furthermore, in the speaker system 10 of the present embodiment, the intersection angle α of intersection of the first and second directions K1 and K2 may be between 0 and 180 degrees. More particularly, the intersection angle α may be between 45 and 135 degrees, since a region can be formed appropriately, in which the sounds from the first and second speaker groups 11 and 12 can interfere with each other.

As is already described, in the present embodiment shown in FIG. 2, it is assumed that the intersection angle α of the first and second directions K1 and K2 is fixed to 90 degrees along the imaginary line L. However, the intersection angle α may be variable.

Furthermore, the first and second inputs respectively inputted to the first and second speaker units 101 and 102 from the signal input unit 300 are assumed to be signals different from, but associated with each other. For example, the first and second inputs may be assumed to be identical in absolute amplitude but shifted in phase from each other by 180 degrees (i.e., opposite in phase to each other). In order to generate such signals, for example, the first input is generated using a signal derived from a single common signal source, and the second input is generated by reversing the phase of the signal.

Although the phase shift described above is preferably 180 degrees from a viewpoint of generating a region where the sounds emitted from the first and second speaker groups 11 and 12 cancel each other out, which will be described later, the phase shift is not limited to 180 degrees, since it is possible to generate a substantially quiet space in the same region using sounds shifted in phase other than 180 degrees as needed according to application.

The first and second inputs are not limited to the above described signals generated from a single signal source. For example, the first and second inputs may be composite signals of signals generated from a plurality of signal sources.

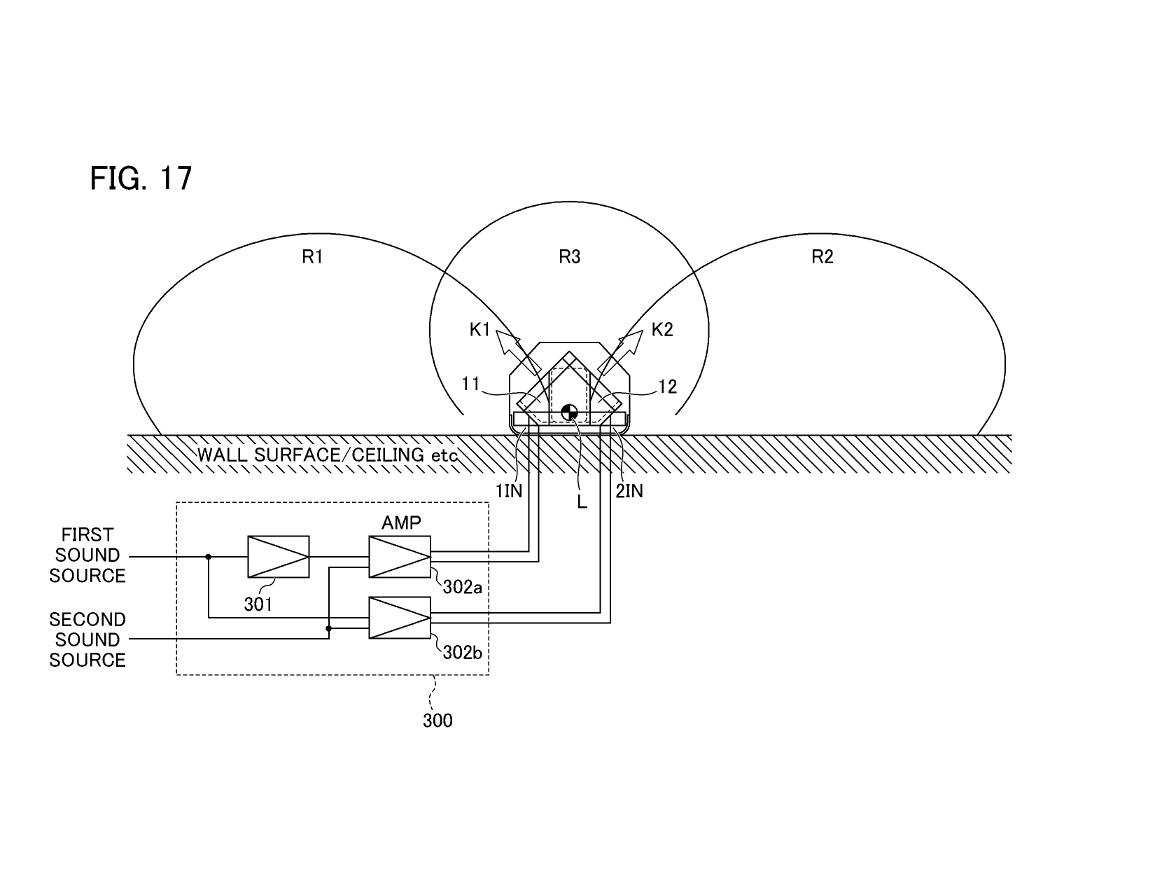

In the case in which the composite signals including signals respectively derived from a plurality of signal sources are employed, processing of phase reversing is performed on a signal (for example, a signal A) from one signal source to generate two signals reverse in phase to each other, the processing of phase reversing is not performed on a signal (for example, a signal B) from the other signal source, and the first and second inputs may be generated by compositing the signal B as it is with the two signals reverse in phase to each other, which will be described later with reference to FIG. 17.

Furthermore, the first and second inputs may be different in amplitude. In this case, the first and second speaker units 101 and 102 respectively included in the first and second speaker groups 11 and 12 may preferably be different in number. In a case in which the first input is twice more in amplitude than the second input, the first speaker group 11 may include half the number of the speaker units as the second speaker group 12.

With regard to layout relationship among the plurality of first speaker units 101 in FIG. 2, the plurality of first speaker units 101 are equidistantly arrayed with a constant pitch. Here, the term “pitch” is intended to mean an interval between adjacent speaker units along the imaginary line L.

In the speaker system 10 of FIG. 2, the plurality of second speaker units 102 are equidistantly arrayed with a constant pitch as well.

Furthermore, the first and second speaker groups 11 and 12 are identical in pitch.

Although, in FIG. 2, the plurality of first speaker units 101 and the plurality of second speaker units 102 are arrayed along the imaginary line L without overlap with each other, there is no limitation thereto. The first and second speaker units 101 and 102 may be arrayed along the imaginary line L so as to partially overlap one on top of another, i.e., so as to be staggered toward the center direction more than shown in FIG. 2.

Alternatively, viewing the speaker system 10 from the front direction F, a central portion C1 of the first sound emission surface G1 may be positioned on a side of the first direction K1 (rightward in FIG. 2) from an intermediate position between the first and second sound emission surfaces G1 and G2, and a central portion C2 of the second sound emission surface G2 may be positioned on a side of the second direction K2 (leftward in FIG. 2) from an intermediate position between the first and second sound emission surfaces G1 and G2. This means that the first and second speaker groups 11 and 12 may be arranged apart from each other by a slight gap, along the imaginary line L extending therebetween. According to this configuration, the sounds emitted from the first and second sound emission surfaces G1 and G2 can efficiently interfere with each other in an intermediate space between the first and second directions K1 and K2 in the front direction F of the speaker system 10.

In the present embodiment, with regard to the layout relationship between the first and second speaker groups 11 and 12, it suffices as long as it is possible to generate an area where the sounds outputted from the first and second speaker groups 11 and 12 can affect each other. More particularly, it suffices as long as it is possible to generate a silent area along the imaginary line L when signals opposite in phase to each other are respectively inputted to the first and second speaker groups 11 and 12. As long as such layout relationships are satisfied, the degrees of the aforementioned “overlap” and “gap” may be selected as appropriate.

Preferably, it suffices as long as the first and second speaker groups 11 and 12 are included in a single outer casing (including, for example, a vehicle, which will be described later) which is transportable as a single entity.

In the example of FIG. 2, a first end portion E1, which is an end portion of an outline Y of the first sound emission surface G1 on the side of the second direction K2, is adjacent to a second end portion E2, which is an end portion of an outline Y of the second sound emission surface G2 on the side of the first direction K1.

As shown in FIG. 3, each of the first speaker unit 101 and the second speaker unit 102 includes a speaker 110 and a speaker box 120.

The speaker system 10 includes one or more first speaker units 101 and one or more second speaker units 102. However, in the present specification, if distinction is not necessary, the first speaker unit 101 and the second speaker unit 102 are inclusively referred to as a “speaker unit 100”.

Furthermore, the first and second speaker units 101 and 102 respectively include the first and second sound emission surfaces G1 and G2. However, in the present specification, if distinction is not necessary, the first sound emission surface G1 and the second sound emission surface G2 are inclusively referred to as a “sound emission surface G”.

Each speaker unit 100 may further include a sound absorbing member (not shown in FIG. 3).

The speaker 110 includes a vibrating member 111, and an actuator 112 that vibrates the vibrating member 111 in accordance with a signal inputted from the signal input unit 300. The speaker 110 further includes a frame 113 and an edge 114. The speaker 110 may be, for example, a dynamic type speaker.

The vibrating member 111 constituting the speaker unit 100 is a member provided with a sound emission surface G that emits a sound, on a front surface of the vibrating member 111. This means that the vibrating member 111 of the first speaker unit 101 is a member provided with a first sound emission surface G1 that emits a sound, on a front surface of the vibrating member 111, and the vibrating member 111 of the second speaker unit 102 is a member provided with a second sound emission surface G2 that emits a sound, on a front surface of the vibrating member 111.

Here, in a case in which each sound emission surface G is flat-shaped, the sound emission surfaces G collectively form a plane parallel to the imaginary line L. As shown in FIG. 2, the vibrating member 111 of the present embodiment has an outline elongated in a direction perpendicular to the imaginary line L. In this case, the vibrating member 111 forms a sound emission surface G having an elongated outline including at least one pair of parallel sides.

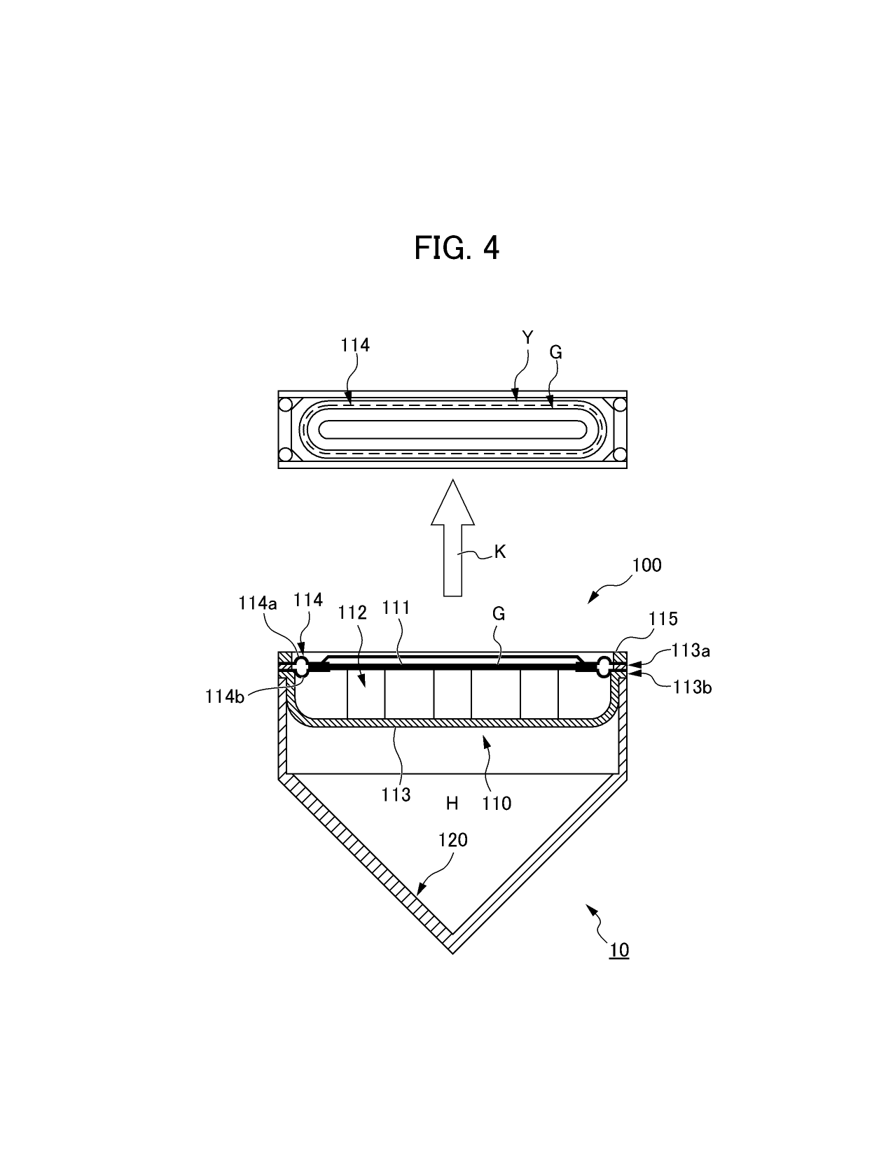

FIG. 4 is a cross sectional view of the speaker unit 100 that constitutes the speaker system 10, and a drawing of one example of the flat shaped sound emission surface G having an elongated outline Y, which is formed by the vibrating member 111 of the speaker unit 100.

As shown in FIG. 4, in the present embodiment, the sound emission surface G formed by the vibrating member 111 has an elongated outline Y including at least one pair of parallel sides. The outline Y shown in FIG. 4 includes a pair of parallel sides and a pair of curved lines that connect respective ends of the pair of parallel sides.

As described above, the vibrating member 111 forms the sound emission surface G having the outline Y including the pair of parallel sides and the pair of curved lines that connect respective ends of the pair of parallel sides. The vibrating member 111 may form a sound emission surface G having an outline Y including a pair of parallel long sides and a pair of short sides that connect respective ends of the pair of long sides.

Returning back to FIG. 3, the actuator 112 drives the vibrating member 111 in accordance with a signal inputted from the signal input unit 300. For example, the actuator 112 may be a voice coil type actuator.

The frame 113 supports the actuator 112. The edge 114 is made of constructional material that vibratably supports the vibrating member 111.

The edge 114 may be supported by the speaker box 120 to vibratably support the vibrating member 111, or may be supported by the frame 113 to vibratably support the vibrating member 111.

The speaker box 120 supports the speaker 110. As well as supporting the speaker 110, the speaker box 120 can form a rear space H enclosed on a rear side of the vibrating member 111.

As shown in FIG. 2, the plurality of speaker units 100 are identical in shape and dimension in regard to the vibrating member 111, the actuator 112, the speaker box 120, and the like. However, as long as, assuming that the first speaker unit 101 and the second speaker unit 102 placed in the closest vicinity in the speaker system 10 are paired as a pair Z, the first speaker unit 101 and the second speaker unit 102 of each pair Z are identical in shape and dimension to each other, the speaker unit 100 may vary in shape and dimension depending on location along the imaginary line L.

The rear space H is substantially sealed except for a little gap caused due to the assembling process.

A cross section of the rear space H cut along a plane perpendicular to the imaginary line L is preferably constant in area along the imaginary line L with a constant pitch. Also, a cross section of the rear space H cut along a plane perpendicular to the imaginary line L is preferably constant in outline shape along the imaginary line L with a constant pitch. As a result thereof, it is possible to stabilize the sounds emitted from the first and second speaker units 101 and 102.

As one example of shape of the sound emission surface G, in a case in which the vibrating member 111 is formed with a sound emission surface G having an outline Y including at least one pair of parallel sides, in the first speaker group 11, the plurality of first speaker units 101 may be arrayed along the imaginary line L in such a manner that the at least one pairs of parallel sides of the outlines Y of the vibrating members 111 constituting the plurality of first speaker units 101 are parallel to one another, and in the second speaker group 12, the plurality of second speaker units 102 may be arrayed along the imaginary line L in such a manner that the at least one pairs of parallel sides of the outlines Y of the vibrating members 111 constituting the plurality of second speaker units 102 are parallel to one another. As a result thereof, it is possible to align the respective sounds emitted from the first and second speaker units 101 and 102 in phase.

As another example of shape of the sound emission surface G, in a case in which the vibrating member 111 is formed with a sound emission surface G having an elongated outline Y including long sides and short sides, in the first speaker group 11, the plurality of first speaker units 101 may be arrayed along the imaginary line L in such a manner that the long sides of the outlines Y of the vibrating members 111 constituting the plurality of first speaker units 101 are parallel to one another, and in the second speaker group 12, the plurality of second speaker units 102 may be arrayed along the imaginary line L in such a manner that the long sides of the outlines Y of the vibrating members 111 constituting the plurality of second speaker units 102 are parallel to one another. As a result thereof, it is possible to align the respective sounds emitted from the first and second speaker units 101 and 102 in phase.

As still another example of shape of the sound emission surface G, in a case in which the vibrating member 111 is formed with a sound emission surface G having an outline Y including two pairs of parallel sides, in the first speaker group 11, the plurality of first speaker units 101 may be arrayed along the imaginary line L in such a manner that the pairs of parallel sides of the outlines Y of the vibrating members 111 thereof are parallel to one another, and in the second speaker group 12, the plurality of second speaker units 102 may be arrayed along the imaginary line L in such a manner that the pairs of parallel sides of the outlines Y of the vibrating members 111 thereof are parallel to one another. As a result thereof, it is possible to align the respective sounds emitted from the first and second speaker units 101 and 102 in phase.

As yet another example of shape of the sound emission surface G, in a case in which the vibrating member 111 is formed with a sound emission surface G having an outline Y including a pair of parallel long sides and a pair of parallel short sides, in the first speaker group 11, the plurality of first speaker units 101 may be arrayed along the imaginary line L in such a manner that the long sides of the outlines Y of the vibrating members 111 thereof are parallel to one another, and in the second speaker group 12, the plurality of second speaker units 102 may be arrayed along the imaginary line L in such a manner that the long sides of the outlines Y of the vibrating members 111 thereof are parallel to one another. As a result thereof, it is possible to align the respective sounds emitted from the first and second speaker units 101 and 102 in phase.

In general, a sound wave attenuates in accordance with a distance from a sound source thereof. Energy of a sound wave emitted from a line sound source is less diffused than that from a point sound source. Furthermore, energy of a sound wave emitted from a plane sound source is less diffused than that from a line sound source. This means that a sound wave emitted from a point sound source propagates in a spherical manner, and the energy of the sound wave is inversely proportional to a square of a distance from the sound source. While, on the other hand, a sound wave emitted from a line sound source propagates in a cylindrical manner, and the energy of the sound wave is inversely proportional to a distance from the sound source. Therefore, a sound wave emitted from a line sound source is less in attenuation rate than that from a point sound source. Furthermore, a sound wave emitted from a plane sound source propagates in a planar manner and the attenuation rate of the sound wave is further less.

As described above, the speaker group including a plurality of sound emission surfaces G each having an outline Y including a pair of parallel long sides and a pair of parallel short sides formed on the vibrating member 111 can be better approximated by a plane sound source than by a point sound source of a single speaker unit. As a result thereof, the speaker group of the above described embodiment can reduce the sound attenuation caused by a distance while being simple in structure, high in output power, and sharp in directivity.

In FIG. 3, each speaker unit 100 constituting the speaker system 10 may include a sound absorbing member filled in the rear space H. The sound absorbing member is a member adapted to attenuate standing waves generated in the rear space H. The sound absorbing member may include a plurality of sound absorbents disposed adjacent to one another in a multilayered manner, wherein the plurality of sound absorbents are different from one another in sound absorption property. The sound absorbents may be made of material which can effectively absorb standing waves generated in the rear space H, and may include, for example, glass wool, a resin plate, or the like.

As shown in FIG. 2, the outer casing 200 serves as a structure to accommodate and support the plurality of speaker units 100.

As shown in FIG. 3, the outer casing 200 includes an outer casing main body 210 and an outer casing cover 220. The outer casing main body 210 is a structural main body of the outer casing 200. The outer casing cover 220 is a member that covers at least a part of the outer casing main body 210 that allows sound transmission. For example, the outer casing cover 220 may be a plate member formed with a plurality of holes and fixed to the outer casing main body 210.

The outer casing 200 supports the first and second speaker groups 11 and 12 arrayed along the imaginary line L. The outer casing 200 supports the plurality of first speaker units 101 arrayed in one line and the plurality of second speaker units 102 arrayed in one line respectively with a constant pitch.

The outer casing 200 supports the plurality of first speaker units 101 arrayed in one line and the plurality of second speaker units 102 arrayed in one line, respectively along the imaginary line L.

In a case in which the first and second speaker groups 11 and 12 respectively include the plurality of first speaker units 101 arrayed in a plurality of lines and the plurality of second speaker units 102 arrayed in a plurality of lines, the plurality of lines of speaker units are supported by the outer casing 200 so as to be arrayed in directions parallel to the imaginary line L.

As described earlier, the outer casing 200 may support the plurality of first speaker units 101 and the plurality of second speaker units 102 in such a manner as to be staggered with each other along the imaginary line L. In this case, the outer casing 200 may support the plurality of first speaker units 101 and the plurality of second speaker units 102 in such a manner as to be staggered with each other along the imaginary line L, and arrayed with the constant pitch.

As shown in FIG. 2, the plurality of first speaker units 101 are arrayed in series with a constant pitch P1, and the plurality of second speaker units 102 are arrayed in series with a constant pitch P2, juxtaposed to the plurality of first speaker units 101. In FIG. 2, the array pitch P1 of the plurality of first speaker units 101 is identical to the array pitch P2 of the plurality of second speaker units 102.

The following description is directed to the operation of the speaker system 10 according to the first embodiment with reference to drawings.

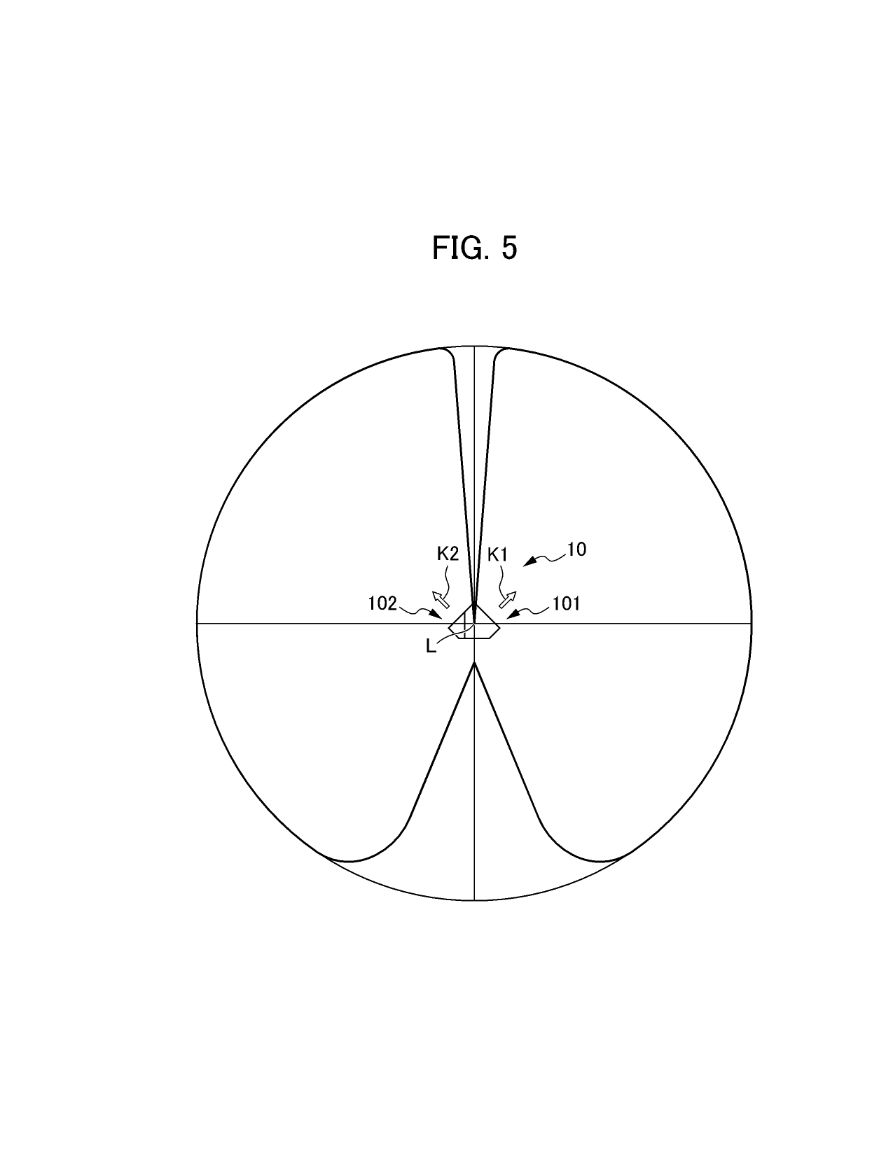

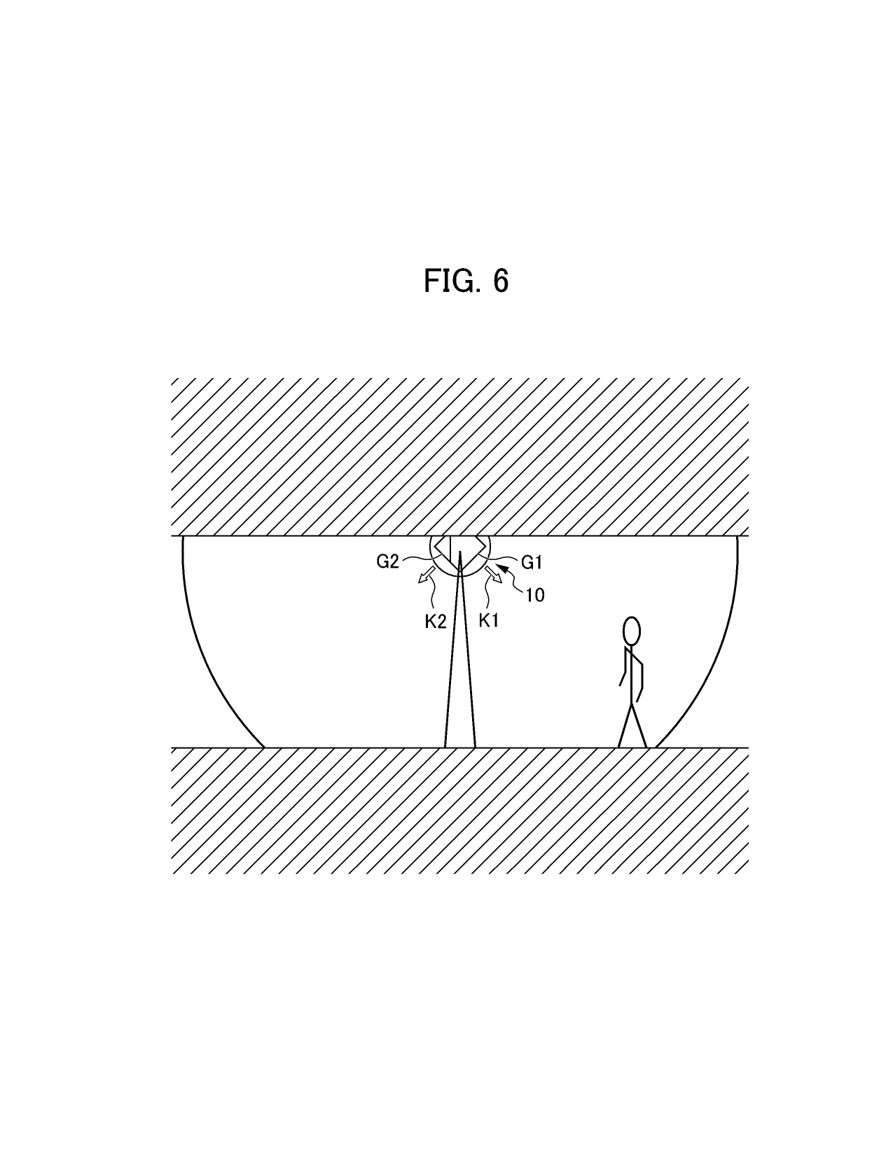

FIG. 5 is a graph showing a directivity pattern of the speaker system 10. FIG. 6 is an explanatory diagram of one exemplary application of the speaker system 10.

In the example of FIG. 6, the angle formed between the first and second directions K1 and K2 is 90 degrees, and the imaginary line L is a straight line. The following description is directed to a case in which processing of generating two signals opposite in phase to each other from a common signal is performed, and the two signals are inputted as the first and second inputs from the signal input unit 300.

FIG. 5 shows a directivity pattern of the speaker system 10 viewed from above the speaker system 10 in a direction parallel to the imaginary line L.

Processing (hereinafter, referred to as “reverse phase processing”) of generating two signals opposite in phase to each other from a common signal (signal derived from a single signal source) is intended to mean, for example, processing on the common signal to acquire a signal (hereinafter, referred to as an “in-phase signal”) identical to the common signal and a signal (hereinafter, referred to as a “reverse phase signal”) shifted in phase by 180 degrees from the common signal. Sound waves outputted based on the two signals acquired by the reverse phase processing have waveforms identical in absolute amplitude but opposite in polarity. Thus, in an area where the two sound waves meet and overlap, sound pressure becomes zero, and accordingly, it is silent. As described above, when signals reverse in phase to each other are inputted to the first and second speaker groups 11 and 12, a silent zone is formed along the imaginary line L, and it is possible to acquire a predetermined directivity pattern.

As shown in FIG. 5, especially at a boundary of two regions subject to the dominant influence of sounds respectively emitted from the first and second speaker groups 11 and 12 of the speaker system 10, since it is equidistant from the respective sound emission surfaces, two sound waves identical in absolute amplitude but shifted in phase by 180 degrees from each other are composited. As a result thereof, the sounds respectively emitted from the first and second speaker groups 11 and 12 cancel each other out and the sound pressure becomes constantly zero. On the other hand, elsewhere than the boundary of the regions subject to dominant influence of respective sounds emitted from the first and second speaker groups 11 and 12, the sound pressure is not constantly zero. Thus, the speaker system 10 has a so-called bidirectional directivity pattern.

As described above, the first and second inputs respectively inputted to the first and second speaker groups 11 and 12 are derived from a common signal but opposite in phase to each other. This causes the generation of a silent space region where the sounds respectively emitted from the first and second speaker groups 11 and 12 cancel each other out, and sound space regions where the sounds do not cancel each other out.

In the silent space region where the sounds cancel each other out, the sounds are not audible. On the other hand, in the sound space regions where the sounds do not cancel each other out, the sounds are audible.

Meanwhile, as described earlier, composite signals of signals respectively generated from a plurality of signal sources may be inputted to the first and second speaker groups 11 and 12. In this case, the reverse phase processing is performed on a signal (for example, a signal A) from one signal source to generate a reverse phase signal and a in-phase signal, and a signal (for example, a signal B) from the other signal source is composited (without performing the reverse phase processing) with the reverse phase signal and the in-phase signal. Then, the composite signal of the reverse phase signal and the signal B may be employed as the first input, and the composite signal of the in-phase signal and the signal B may be employed as the second input.

As a result thereof, the sound of the signal A, on which the reverse phase processing has been performed, is not audible in the above described silent space region, but the sound of the signal B, on which the reverse phase processing has not been performed, is audible even in the silent space region. On the other hand, in the sound space regions where the sounds reverse in phase to each other do not cancel each other out, the sounds of the both signals A and B are audible.

FIG. 1 and FIG. 6 show a case in which the speaker system 10 is installed in an elongated cavity space such as an underground passage.

Here, it is assumed that the speaker system 10 is installed in a ceiling of the cavity space in such a manner that the imaginary line L of the speaker system 10 is perpendicular to a longitudinal direction of the cavity space, and the first and second sound emission surfaces G1 and G2 face downwardly.

In a case in which the prior art speaker system is similarly installed, problems occur in that sound is heard very loudly, noisy, hardly audible, or the like, depending on the location for a pedestrian immediately below the speaker system, which has been described earlier. However, in the present embodiment, when a pedestrian comes immediately below the speaker system 10, the sounds emitted from the first and second speaker groups 11 and 12 maintain reverse phase relationship to each other, and cancel each other out precisely. Therefore, the pedestrian hears no direct sound from the speaker system 10, and only hears a reflected sound from surrounding walls. Accordingly, it is possible to avoid the problem such that the pedestrian immediately below the speaker system 10 hears a sound that is very loud, noisy, hardly audible, or the like.

The pedestrian hears the direct sound from the speaker system 10 when located elsewhere than immediately below the speaker system 10.

As a result thereof, the pedestrian can hear sounds approximately equal in loudness anywhere in the cavity space.

### Second Embodiment

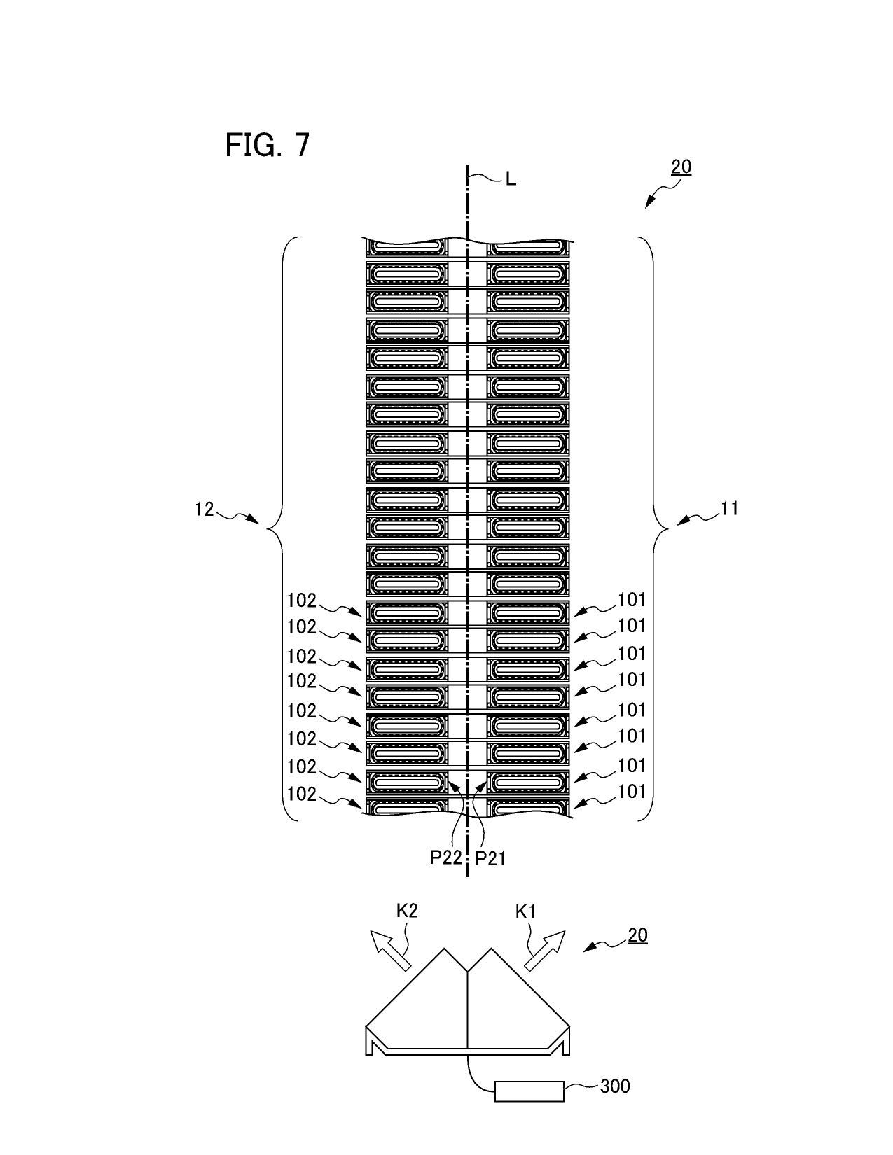

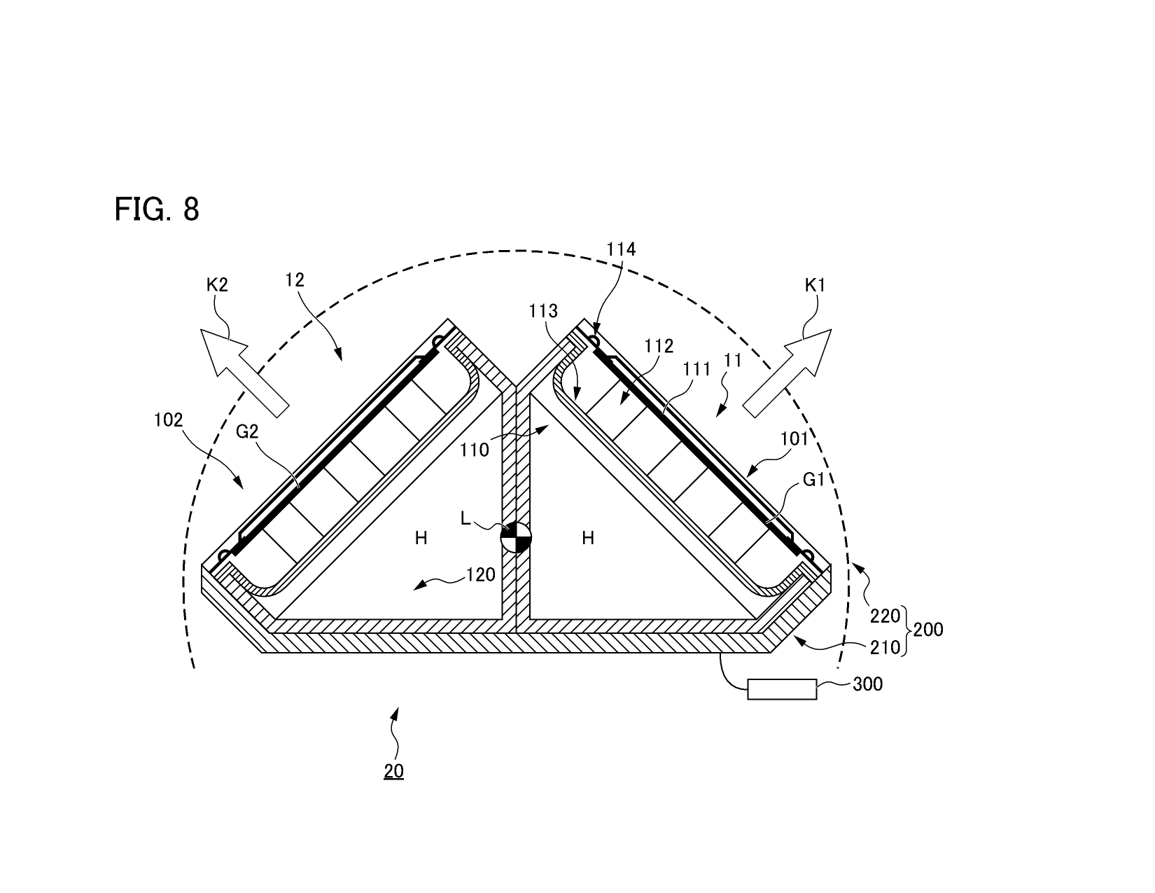

In the following, a description will be given of a speaker system 20 according to a second embodiment of the present invention with reference to drawings. FIG. 7 is a schematic view and a front view of the speaker system 20 according to the second embodiment of the present invention. FIG. 8 is a cross sectional view of the speaker system 20 according to the second embodiment of the present invention.

The speaker system 20 according to the second embodiment is provided with a first speaker group 11, a second speaker group 12, and a signal input unit 300.

Similarly to the above described first embodiment, the speaker system 20 of the second embodiment includes a plurality of speaker units 100 and an outer casing 200. Similar constituent elements are denoted by the same symbols, and detailed description thereof and drawings are omitted.

Since the first and second directions K1 and K2, the first and second speaker groups 11 and 12, and the like are also similar to those of the speaker system 10 according to the first embodiment, similar constituent elements thereof are denoted by the same symbols, and detailed description thereof is omitted.

As shown in the schematic view of FIG. 7, in the speaker system 20 of the present embodiment, the plurality of first speaker units 101 and the plurality of second speaker units 102 are closely arrayed along the imaginary line L.

In the present embodiment, as shown in FIG. 7, the plurality of first speaker units 101 and the plurality of second speaker units 102 are arrayed juxtaposing to each other in two lines along the imaginary line L.

The plurality of first speaker units 101 are arrayed in series with a constant pitch P21, and the plurality of second speaker units 102 are arrayed in series with a constant pitch P22, juxtaposing to the plurality of first speaker units 101.

In FIG. 7, the array pitch P21 of the plurality of first speaker units 101 is identical to the array pitch P22 of the plurality of second speaker units 102.

As shown in FIG. 8, in the present embodiment, similarly to the first embodiment, the first speaker units 101 and the second speaker units 102 are arrayed juxtaposing to each other along the imaginary line L. The speaker system 20 is provided with the plurality of speaker units 100 and the outer casing 200.

Since the structures of the plurality of speaker units 100 and the outer casing 200 are similar to those of the speaker system 10 according to the first embodiment, the description thereof is omitted.

In the speaker system 20 according to the second embodiment, in addition to the similar effects to the speaker system 10 according to the first embodiment, it is expected to have an effect that the first and second speaker units 101 and 102 can be arranged along the imaginary line L in a manner closer than those of the first embodiment.

### Third Embodiment

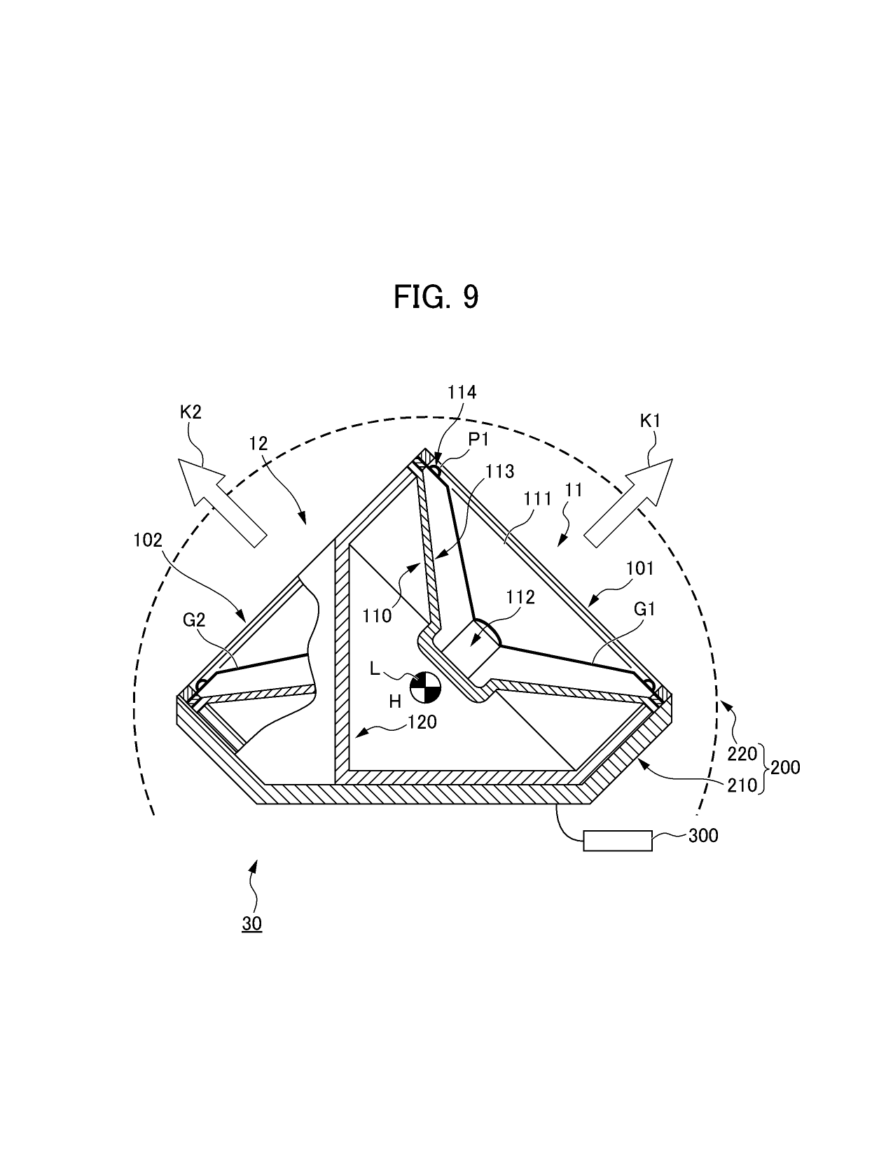

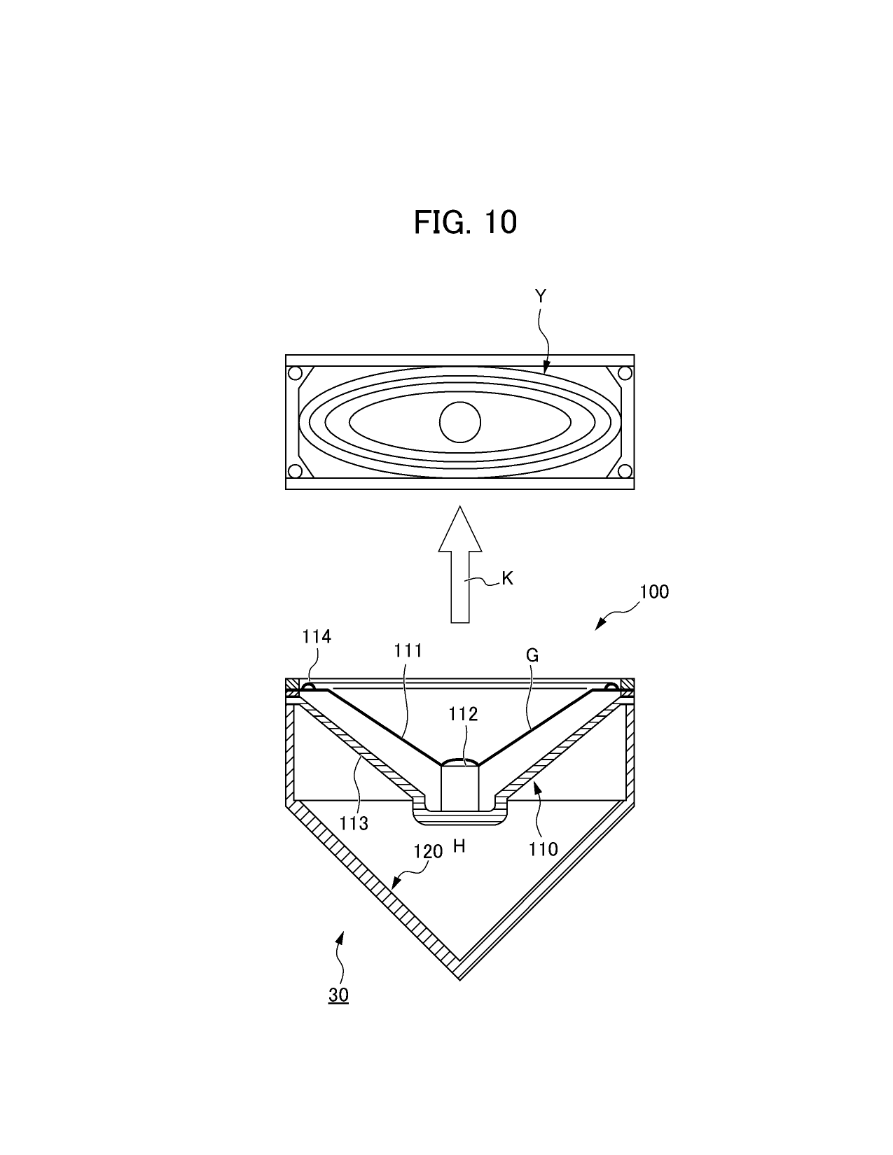

In the following, a description will be given of a third embodiment of the present invention with reference to drawings. FIG. 9 is a cross sectional view of a speaker system 30 according to the third embodiment of the present invention. FIG. 10 is a cross sectional view of the speaker unit 100 constituting the speaker system 30 according to the third embodiment, and a diagram showing one example of the sound emission surface G of the speaker unit 100.

The speaker system 30 according to the third embodiment is provided with a first speaker group 11, a second speaker group 12, and a signal input unit 300. Similarly to the above described embodiments, the speaker system 30 according to the present embodiment includes a plurality of speaker units 100 and an outer casing 200. Unlike the first and second embodiments, the speaker unit 100 of the third embodiment is formed with a sound emission surface G of a conical shape. Similar constituent elements are denoted by the same symbols, and detailed description thereof and drawings are omitted.

Since the first and second speaker groups 11 and 12, and the like are the same as those of the speaker system 10 according to the first embodiment, description thereof is omitted.

Each speaker unit 100 constituting the first and second speaker groups 11 and 12 includes a speaker 110 and a speaker box 120.

Each speaker unit 100 may further include a sound absorbing member (not shown). For example, the speaker 110 may be a dynamic type speaker.

The vibrating member 111 is a member formed with the sound emission surface G that emits sounds, on a front surface of the vibrating member 111. The vibrating member 111 of the present embodiment is formed with the sound emission surface G of a conical shape, on a front surface of the vibrating member 111. This means that the vibrating member 111 is formed with the conical shaped sound emission surface G centering on an axis perpendicularly intersecting with the imaginary line L.

As shown in FIG. 10, which will be described later, the vibrating member 111 has an outline elongated in a direction perpendicular to the imaginary line L, and is formed with the sound emission surface G having an elongated outline.

The vibrating member 111 is formed with the sound emission surface G having an outline including at least one pair of parallel sides. By employing a vibrating member 111 having an outline elongated in a direction perpendicular to the imaginary line L, even if the speaker unit 100 is formed with a conical shaped sound emission surface G, it is possible to reduce a spread of a sound wave outputted from the speaker units 100 in a direction of the imaginary line L.

FIG. 10 is a cross sectional view of the speaker unit 100 constituting the speaker system 30 and a diagram showing one example of the sound emission surface G of the speaker unit 100. In the present embodiment, the vibrating member 111 is formed with the sound emission surface G of a conical shape, on a front surface of the vibrating member 111, and the sound emission surface G has an elongated outline of an elliptical shape.

In the first and second embodiments (for example, FIG. 4), it has been described that the sound emission surface G is in a flat shape along a plane parallel to the imaginary line L. The present embodiment is different from the above described embodiments in that the sound emission surface G is of a conical shape. However, even if the sound emission surface G is of a conical shape, by employing the above described elongated outline, similarly to the case of employing the flat shaped sound emission surface G as shown in FIG. 4, it is possible to emit a sound wave with a sharp directivity in a direction perpendicular to the imaginary line L.

The vibrating member 111 may be formed with a sound emission surface G that has an outline including a pair of parallel sides and a pair of curved lines that smoothly connect respective ends of the pair of parallel sides. Furthermore, the vibrating member 111 may be formed with a sound emission surface G that has an outline including a pair of parallel long sides and a pair of parallel short sides.

Since the actuator 112, the frame 113, the edge 114, and the like are similar to those of the speaker system 10 according to the first embodiment, description thereof is omitted.

In the speaker system 30 according to the third embodiment, the sound emission surface G is of a conical shape. Therefore, in addition to the similar effects to the speaker system 10 according to the first embodiment, it is possible to have an effect of high durability, reduced split vibration, and especially high performance in low frequency reproduction.

### Fourth Embodiment

In the following, a description will be given of a speaker system according to a fourth embodiment with reference to drawings.

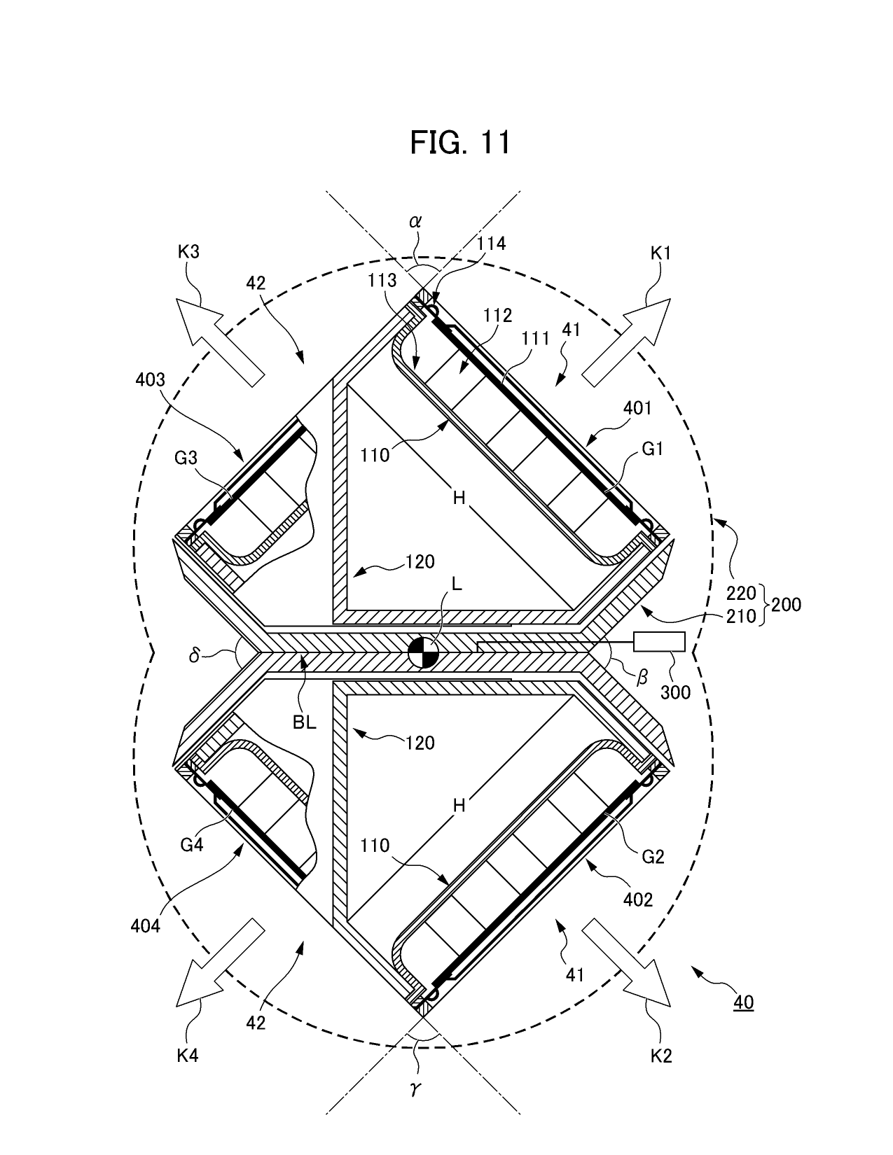

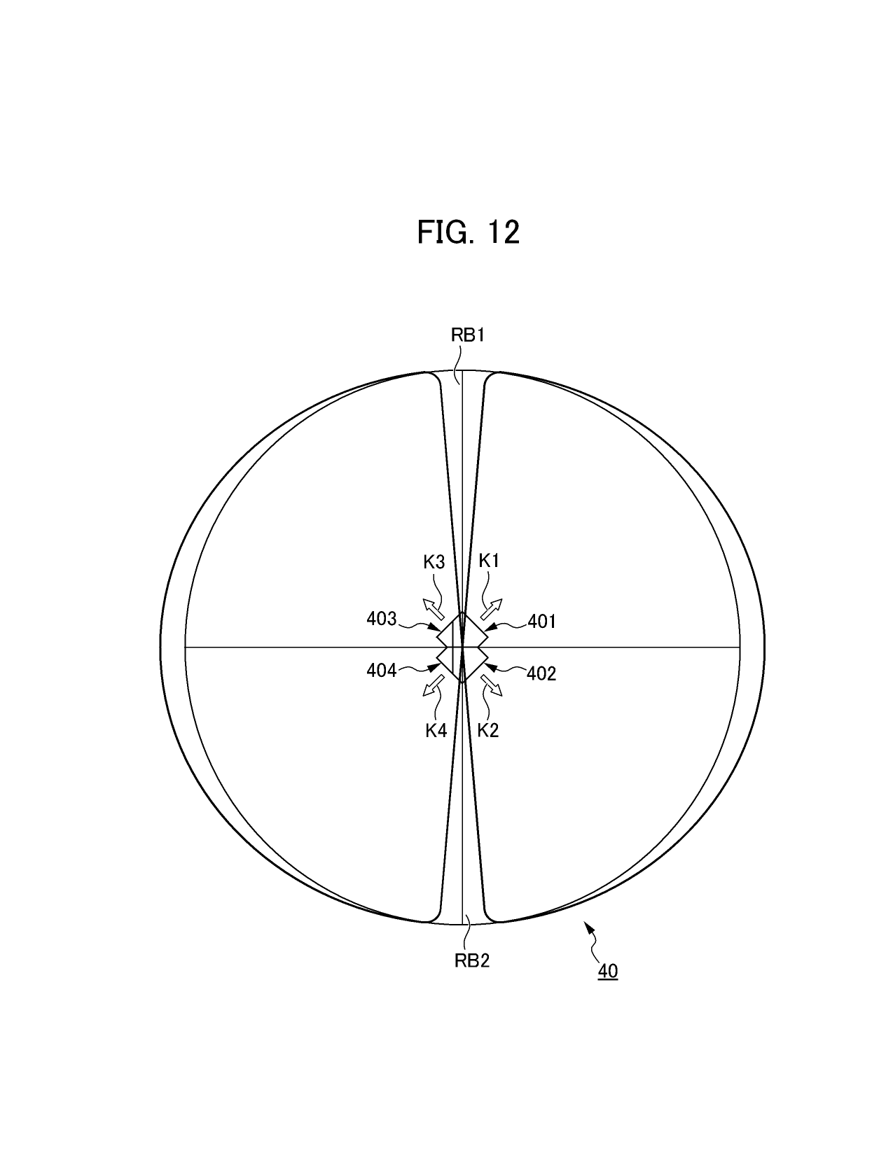

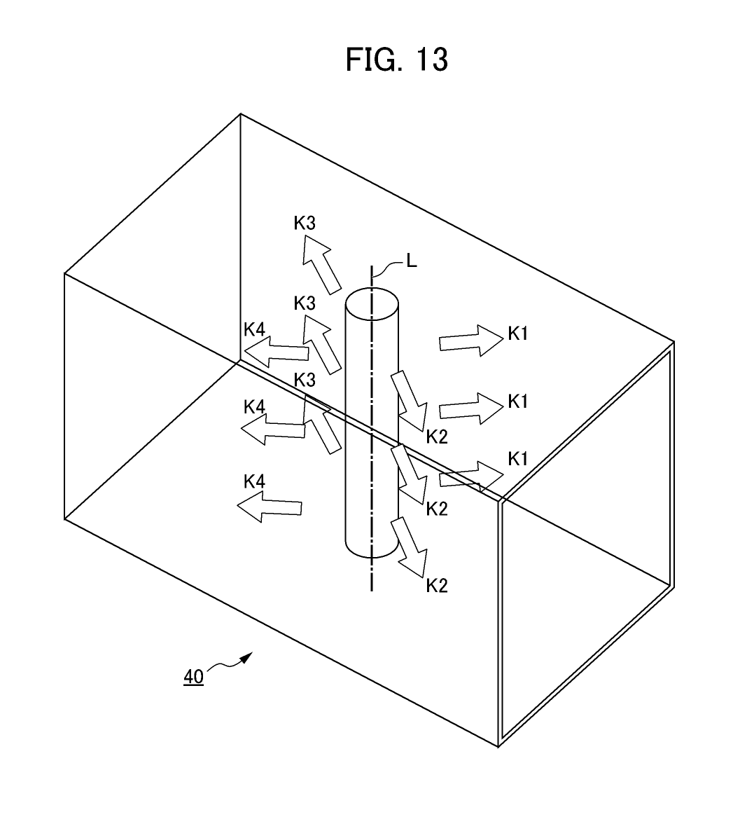

FIG. 11 is a cross sectional view of a speaker system 40 according to the fourth embodiment. FIG. 12 is a diagram showing a directivity pattern of the speaker system 40 according to the fourth embodiment. FIG. 13 is a schematic explanatory diagram of the speaker system 40 according to the fourth embodiment. Similar constituent elements to the above described embodiments are denoted by the same symbols, and description thereof is omitted.

The speaker system 40 according to the fourth embodiment includes a first speaker group 41, a second speaker group 42, and a signal input unit 300.

The first speaker group 41 is provided with a first and second sound emission surfaces G1 and G2 that are surfaces to emit sounds, and emits sounds from the first and second sound emission surfaces G1 and G2 in accordance with a first input inputted to the speaker system 40 from the signal input unit 300.

The second speaker group 42 is provided with a third and fourth sound emission surfaces G3 and G4 that are surfaces to emit sounds, and emits sounds from the third and fourth sound emission surfaces G3 and G4 in accordance with a second input inputted to the speaker system 40 from the signal input unit 300.

The first speaker group 41 includes pluralities of first and second speaker units 401 and 402, respectively arrayed in one line, and the sound emission surfaces of the pluralities of first and second speaker units 401 and 402 respectively form the first and second sound emission surfaces G1 and G2. Similarly, the second speaker group 42 includes pluralities of third and fourth speaker units 403 and 404, respectively arrayed in one line, and the sound emission surfaces of the pluralities of third and fourth speaker units 403 and 404 respectively form the third and fourth sound emission surfaces G3 and G4.

Here, the imaginary line L is assumed similarly to the previous embodiments. First and second directions K1 and K2 are respectively defined as approximate normal directions of the first and second sound emission surfaces G1 and G2, toward which the first and second sound emission surfaces G1 and G2 respectively face. Similarly, third and fourth directions K3 and K4 are respectively defined as approximate normal directions of the third and fourth sound emission surfaces G3 and G4, toward which the third and fourth sound emission surfaces G3 and G4 respectively face.

Although the imaginary line L is preferably a straight line, as described in previous embodiments, the imaginary line L may be a curved line. In the speaker system 40, even if the first and second speaker units 401 and 402 and the third and fourth speaker units 403 and 404 are arrayed along respective curved lines, embodiments of the present invention are still applicable. In the present embodiment, it is assumed that the imaginary line L is a straight line. However, in the present embodiment, the first to fourth directions K1 to K4 may be changed depending on location along the extending direction of the imaginary line L, as described earlier in previous embodiments.

The speaker system 40 includes the first, second, third, and fourth speaker units 401, 402, 403, and 404, which hereinafter will be inclusively referred to as the “speaker unit 400” if distinction is not necessary.

The speaker system 40 includes the plurality of speaker units 400 and an outer casing 200.

As described earlier, the first speaker group 41 constituting the speaker system 40 includes the plurality of first and second speaker units 401 and 402, and the second speaker group 42 constituting the speaker system 40 includes the plurality of third and fourth speaker units 403 and 404.

The sound emission surfaces of the plurality of first speaker units 401 form the first sound emission surface G1, and the sound emission surfaces of the plurality of second speaker units 402 form the second sound emission surface G2. Also, the sound emission surfaces of the plurality of third speaker units 403 form the third sound emission surface G3, and the sound emission surfaces of the plurality of fourth speaker units 404 form the fourth sound emission surface G4.

A detailed description will be given later of the speaker units 400 and the first and second speaker groups 41 and 42. However, structure and features of each speaker unit 400 may be similar to the speaker unit 100 of the embodiments described above.

The first to fourth directions K1 to K4 constantly form predetermined intersection angles α, β, γ, and δ on a plane perpendicular to the imaginary line L of the speaker system 40.

A salient angle of intersection of the first and third directions K1 and K3 defines the above described intersection angle α.

Also, a salient angle of intersection of the first and second directions K1 and K2 defines the above described intersection angle β.

Similarly, a salient angle of intersection of the second and fourth directions K2 and K4 defines the intersection angle γ, and a salient angle of intersection of the third and fourth directions K3 and K4 defines the intersection angle 5.

In the present embodiment, these intersection angles α, β, γ, and δ are constant and assumed to be rectangular.

The intersection angles α, β, γ, and δ may be within a range between 0 and 180 degrees, and more particularly, between 45 and 135 degrees. As described earlier in previous embodiments, the intersection angles α, β, γ, and δ may be respectively variable according to a location along the imaginary line L.

In the first speaker group 41, the first direction K1 of the first speaker units 401 and the second direction K2 of the second speaker units 402 are symmetrical with respect to a boundary plane BL shown in FIG. 11. Also, in the second speaker group 42, the third direction K3 of the third speaker units 403 and the fourth direction K4 of the fourth speaker units 404 are symmetrical with respect to the boundary plane BL.

As described earlier, in the present embodiment, the intersection angles α, β, γ, and δ are assumed to be rectangular. Therefore, the first to fourth directions K1 to K4 approximately quadrisect a plane perpendicular to the imaginary line L.

The imaginary line L is preferably a straight line. However, as described earlier in previous embodiments, the imaginary line L may be a curved line. This means that embodiments of the present invention are applicable even if the speaker system 40 is provided with a plurality of sets of first and second speaker units 401 and 402 and a plurality of sets of third and fourth speaker units 403 and 404 arrayed along a curved imaginary line L.

As described earlier, the intersection angles α, β, γ, and δ formed by the first to fourth directions K1 to K4 may be changed along the imaginary line L.

The first and second inputs respectively inputted to the first and second speaker groups 41 and 42 from the signal input unit 300 are signals different from but associated with each other. For example, the first and second inputs are assumed to be generated from a common signal but opposite in phase to each other. In order to generate such signals, for example, the above described reverse phase processing is performed on a signal from a single common signal source to generate the reverse phase signal and the in-phase signal respectively as the first and second inputs.

Similarly to the description of the previous embodiments, the first and second inputs are not limited to the above described signals generated from a single signal source. For example, the first and second inputs may be composite signals of signals generated from a plurality of signal sources.

In the case in which the composite signals of signals generated from a plurality of signal sources are employed, the reverse phase processing is performed on a signal (for example, a signal A) from one signal source to generate the reverse phase signal and the in-phase signal, and a signal (for example, a signal B) from the other signal source is composited (without performing the reverse phase processing) with the reverse phase signal and the in-phase signal. The resultant composite signal of the reverse phase signal and the signal B may be employed as the first input, and the resultant composite signal of the in-phase signal and the signal B may be employed as the second input.

Furthermore, the first and second inputs may be different from each other in amplitude. In this case, the first and second speaker groups 41 and 42 may include different numbers of speaker units. In a case in which the first input is twice more in amplitude than the second input, the first speaker group 41 may include half the number of speaker units as the second speaker group 42.

In the present embodiment, it is assumed that each of the first and second speaker groups 41 and 42 include a plurality of speaker units. However, there is no limitation thereto, and each of the first and second speaker groups 41 and 42 may include only one speaker unit.

Although, in the speaker system 40 of the present embodiment, the first speaker group 41 includes the pluralities of first and second speaker units 401 and 402 arrayed in one line, the first and second speaker units 401 and 402 may be respectively arrayed in a plurality of lines. The same is applied to the second speaker group 42.

Furthermore, as described earlier in the previous embodiments, the speaker units may be staggered one on top of another, and may be arrayed in respective lines with a constant pitch.

Since the structure of the speaker unit 400 is similar to the speaker unit 100 according to the first embodiment, description thereof is omitted.

The following description is directed to the operation of the speaker system 40 according to the present embodiment.

FIG. 12 is a diagram showing a directivity pattern of the speaker system 40 according to the present embodiment. FIG. 13 is an explanatory perspective view of the speaker system 40 according to the present embodiment.

In the following, it is assumed that the intersection angles α, β, γ, and δ formed by the first to fourth directions K1 to K4 are rectangular, and the imaginary line L is a straight line. Under these premises, description will be given of an exemplary case in which the signal input unit 300 inputs the reverse phase signal and the in-phase signal acquired by the reverse phase processing from a common signal as the first and second inputs to the speaker system 40.

FIG. 12 shows a directivity pattern of the speaker system 40 viewed from above along the imaginary line L.

The directivity pattern is uniform along the imaginary line L. As shown in FIG. 12, in the speaker system 40, especially at boundaries RB1 and RB2 (regions formed on upper and lower parts in the sheet of FIG. 12) of regions subject to influence of respective sounds emitted from the first speaker group 41 (the first and second speaker units 401 and 402) and the second speaker group 42 (the third and fourth speaker units 403 and 404), the sound emitted from the first and second speaker units 401 and 402 and the sound emitted from the third and fourth speaker units 403 and 404 cancel each other out and the sound pressure becomes constantly zero. On the other hand, elsewhere than the boundaries RB1 and RB2 of regions subject to influence of the sound emitted from the first and second speaker units 401 and 402 and the sound emitted from the third and fourth speaker units 403 and 404, the sound pressure is not constantly zero. Thus, the speaker system 40 has a so-called bidirectional directivity.

Similarly to the description of the previous embodiments, in the present embodiment as well, respective composite signals of signals generated from a plurality of signal sources may be provided to the first and second speaker groups 41 and 42.

Especially in the present embodiment, since there are four sets of speaker units 401 to 404, two silent spaces can be formed on the upper and lower parts in the sheet of FIG. 12. In this case, the reverse phase processing is performed on a signal (for example, a signal A) from one signal source to generate the reverse phase signal and the in-phase signal, and a signal (for example, a signal B) from the other signal source is composited as it is (without performing the reverse phase processing) with the reverse phase signal and the in-phase signal. Then, the resultant composite signal of the reverse phase signal and the signal B may be provided to the first and second speaker units 401 and 402, and the resultant composite signal of the in-phase signal and the signal B may be provided to the third and fourth speaker units 403 and 404.

In the exemplary case of FIG. 12, the first and second speaker units 401 and 402 of the first speaker group 41 are supplied with the reverse phase signal, and the third and fourth speaker units 403 and 404 of the second speaker group 42 are supplied with the in-phase signal. However, there is no limitation thereto.

For example, the first and third speaker units 401 and 403 may be supplied with the reverse phase signal, and the second and fourth speaker units 402 and 404 may be supplied with the in-phase signal. In this case, the silent region, where sound pressure is zero, is formed in the left and right directions in the sheet of FIG. 12.

Furthermore, the first and fourth speaker units 401 and 404 may be supplied with the reverse phase signal, and the second and third speaker units 402 and 403 may be supplied with the in-phase signal. In this case, the silent region, where sound pressure is zero, is formed in the upper, lower, left, and right directions in the sheet of FIG. 12.

It is needless to mention that, from among the inputs to be inputted to the speaker units, the number of reverse phase signals to be employed as the inputs, and the inputs to which the reverse phase signals are inputted, are selectable as appropriate.

Furthermore, the number of sets of speaker units is not limited to four (corresponding to four directions K1 to K4) and may be three or more than four. It suffices as long as a region is formed where respective sounds from one set of speaker units and another set of speaker units can interfere with each other. Here, in the case in which respective composite signals of signals generated from a plurality of signal sources are provided to the first and second speaker groups 41 and 42, it is selectable as appropriate whether or not the reverse phase processing is performed on each signal source in order to acquire the sounds.

FIG. 13 shows an exemplary case in which the speaker system 40 is vertically installed in an elongated cavity space such as an underground passage.

Here, the speaker system 40 is installed in such a manner that the imaginary line L is perpendicular to the ground and the level of the directivity pattern reaches its maximum in a longitudinal direction of the cavity space.

According to this configuration, when a person stands on a wall side of the speaker system 40, sounds directly delivered from the speaker system 40 vanishes, and the person will hear only sounds reflected from the wall in the vicinity. On the other hand, when the person stands elsewhere than on the wall side of the speaker system 40, the person will hear sounds directly transmitted from the speaker system 40.

As a result thereof, the person can hear a sound of approximately equal loudness anywhere in the cavity space.

In the following, a detailed description will be given of a plurality of examples of types of the speaker 110 applicable to the speaker system according to embodiments of the present invention with reference to drawings.

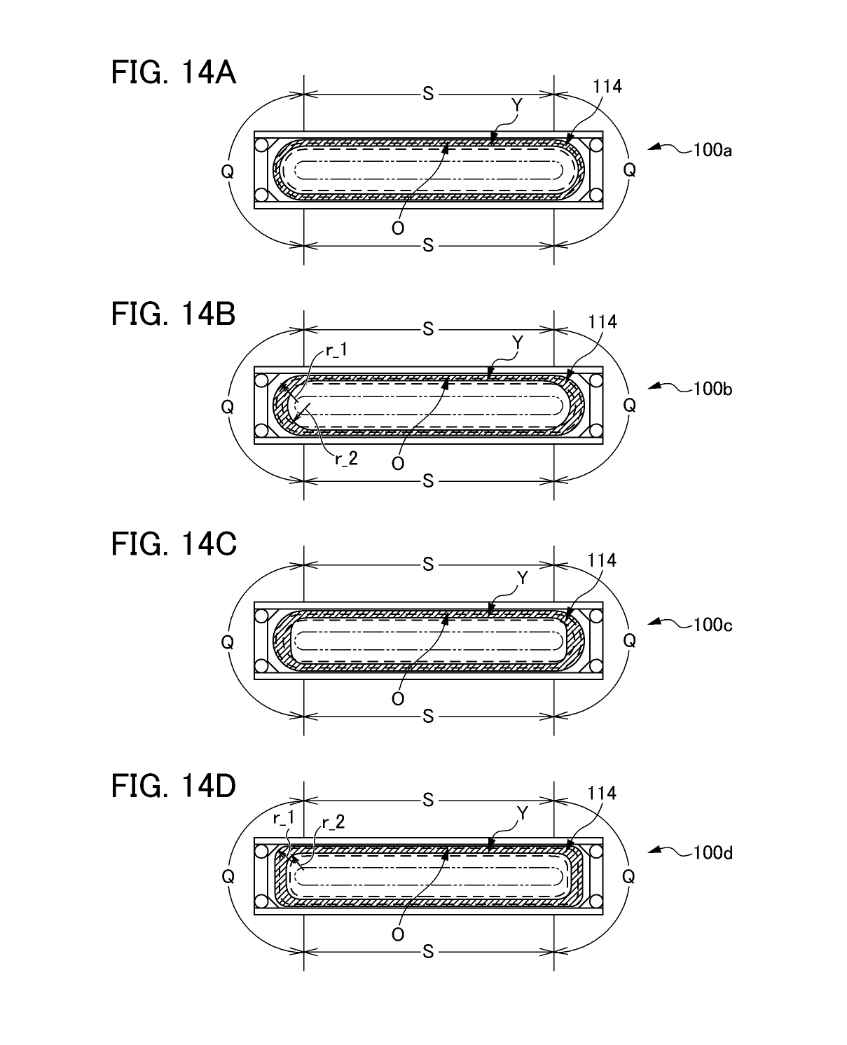

FIG. 14 is a diagram showing sound emission surfaces of four types of speakers 110a, 110b, 110c, and 110d, which are applicable to some embodiments of the present invention. The speakers 110a, 110b, 110c, and 110d shown in FIG. 14 are applicable to, for example, the speaker system according to the first to fourth embodiments of the present invention.

The sound emission surfaces of the speakers 110a, 110b, 110c, and 110d may be of a flat shape and/or may be of a conical shape.

Hereinafter, a brief description will be given of configurations of the speakers 110a, 110b, 110c, and 110d with reference to FIGS. 14 and 4. Each of the speakers 110a, 110b, 110c, and 110d includes the vibrating member 111, the frame 113, the edge 114, and the actuator 112.

Each of the speakers 110a, 110b, 110c, and 110d may include a plurality of actuators 112, and may further include a cover frame 115.

Here, it is assumed that the vibrating member 111 of the speakers 110a, 110b, 110c, and 110d is a plate-like member having a flat shaped sound emission surface.

The vibrating member 111 is a flat plate including a vibrating member outer peripheral part that is an outer peripheral part forming an outline Y. The outline Y is formed with one pair of straight line portions S and one pair of flexure line portions Q alternately connected.

The flexure line constituting the flexure line portion Q is a polygonal line, a curved line, or a combination of one or more polygonal lines and one or more curved lines. The vibrating member 111 includes a vibrating member front plate, a vibrating member main body, and a vibrating member rear plate.

The vibrating member front plate is a plate member that forms a front surface of the vibrating member 111, and is adhered to a front side of the vibrating member main body. The vibrating member main body is a plate member having a predetermined thickness. The vibrating member rear plate is a plate member that forms a rear surface of the vibrating member 111, and is adhered to a rear side of the vibrating member main body.

Referring back to FIG. 4, the frame 113 is a main structural body of the speaker 110 that supports the actuator 112, which will be described later. As shown in FIG. 14, the frame 113 includes a frame opening part O that is an opening part surrounded by a frame inner peripheral part having an outline including one pair of straight line portions S and one pair of flexure line portions Q alternately connected. The frame 113 may include a sub frame 113a and a main frame 113b. For example, the main frame 113b may support the actuator 112 and fix the sub frame 113a, and the sub frame 113a may form the frame opening part O.

The sub frame 113a may be lower in elastic modulus than the main frame 113b. For example, the sub frame 113a may be made of resin, and the main frame 113b may be made of metal.

The sub frame 113a may be a plate member, and may have a surface to which an edge outer peripheral part is fixed. For example, the sub frame 113a may have surfaces, to which the edge outer peripheral part is fixed, on front and rear surfaces of the sub frame 113a.

The sub frame 113a may have a surface, to which the edge outer peripheral part is fixed, on a different level from the surface of the plate member of the sub frame 113a.

The vibrating member 111 fits in the frame opening part O so that the vibrating member outer peripheral part does not contact the frame inner peripheral part.

Hereinafter, a detailed description will be given of the vibrating member outer peripheral part, the frame inner peripheral part, and a gap formed therebetween of the speaker 110 with reference to FIG. 14. For ease of description, the edge 114 is shown by a shaded area.

The pair of straight line portions S of the outline of the vibrating member outer peripheral part may respectively face toward the pair of straight line portions S of the outline of the frame inner peripheral part. The pair of flexure line portions Q of the outline of the vibrating member outer peripheral part may respectively face toward the pair of flexure line portions Q of the outline of the frame inner peripheral part.

The center of curvature of a curved line included in the flexure line portion Q of the vibrating member outer peripheral part is located more inside than the center of curvature of a curved line included in the flexure line portion Q of the frame inner peripheral part.

As a result thereof, the gap between the respective straight line portions S of the vibrating member outer peripheral part and the frame inner peripheral part is constant in width, and the gap between the respective flexure line portions Q of the vibrating member outer peripheral part and the frame inner peripheral part becomes wider from both ends toward the middle thereof.

For example, the gap between the respective flexure line portions Q of the vibrating member outer peripheral part and the frame inner peripheral part may be equal in width to the gap between the respective straight line portions S of the vibrating member outer peripheral part and the frame inner peripheral part.

In the sound emission surface shown in FIG. 14A, the outline Y is formed of one pair of flexure line portions Q and one pair of straight line portions S alternately connected, and the gap between the respective flexure line portions Q of the vibrating member outer peripheral part and the frame inner peripheral part is equal in width to the gap between the respective straight line portions S of the vibrating member outer peripheral part and the frame inner peripheral part.

For simplicity, hereinafter, the both end points of the flexure line portion Q are assumed to be respective endpoints of the straight line portions S on both sides of the flexure line portion Q, and not to belong to the flexure line portion Q.

For example, the gap between the respective flexure line portions Q of the vibrating member outer peripheral part and the frame inner peripheral part may be wider than the gap between the respective straight line portions S of the vibrating member outer peripheral part and the frame inner peripheral part.

For example, the gap between the respective straight line portions S of the vibrating member outer peripheral part and the frame inner peripheral part may be constant in width, and the gap between the respective flexure line portions Q of the vibrating member outer peripheral part and the frame inner peripheral part may become wider from both ends toward the middle thereof.

In the sound emission surfaces shown in FIGS. 14B to 14D, the gap between the respective flexure line portions Q of the vibrating member outer peripheral part and the frame inner peripheral part is wider than the gap between the respective straight line portions S of the vibrating member outer peripheral part and the frame inner peripheral part.

For example, the flexure line portions Q of the frame inner peripheral part and the vibrating member outer peripheral part may be curved lines having respective predetermined curvature radii, the flexure line portion Q of the frame inner peripheral part may smoothly connect the straight line portions S thereof, the flexure line portion Q of the vibrating member outer peripheral part may smoothly connect the straight line portions S thereof, and the center of curvature of the curved line of the vibrating member outer peripheral part may be located more inside than that of the curved line of the frame inner peripheral part.

In the sound emission surface shown in FIG. 14B, the outline Y is formed of one pair of flexure line portions Q and one pair of straight line portions S alternately connected, and the flexure line portions Q of the frame inner peripheral part and the vibrating member outer peripheral part are curved lines having respective predetermined curvature radii, the flexure line portion Q of the frame inner peripheral part smoothly connects the straight line portions S thereof, the flexure line portion Q of the vibrating member outer peripheral part smoothly connects the straight line portions S thereof, and the center of curvature of the curved line of the vibrating member outer peripheral part is located more inside than that of the curved line of the frame inner peripheral part.

Assuming that the flexure line portion Q of the vibrating member outer peripheral part has a curvature radius r_2, and the flexure line portion Q of the frame inner peripheral part has a curvature radius r_1, the curvature radius r_2 of the flexure line portion Q of the vibrating member outer peripheral part may be approximately equal to the curvature radius r_1 of the flexure line portion Q of the frame inner peripheral part.

In the sound emission surface shown in FIG. 14C, the outline Y is formed of one pair of flexure line portions Q and one pair of straight line portions S alternately connected, the flexure line portion Q of the vibrating member outer peripheral part is a polygonal line, the flexure line portion Q of the frame inner peripheral part connects the straight line portions S thereof, the flexure line portion Q of the vibrating member outer peripheral part connects the straight line portions S thereof, and the gap between the respective flexure line portions Q of the vibrating member outer peripheral part and the frame inner peripheral part is wider than the gap between the respective straight line portion S of the vibrating member outer peripheral part and the frame inner peripheral part.

The vibrating member 111 fits in the frame opening part O so that the vibrating member outer peripheral part does not contact the frame inner peripheral part.

The pair of straight line portions S of the outline of the vibrating member outer peripheral part of the vibrating member 111 respectively face toward the pair of straight line portions S of the outline of the frame inner peripheral part.

As a result thereof, the gap between the respective straight line portions S of the vibrating member outer peripheral part and the frame inner peripheral part is constant in width, and the gap between the respective flexure line portions Q of the vibrating member outer peripheral part and the frame inner peripheral part becomes wider from both ends toward the middle thereof.

In the sound emission surface shown in FIG. 14D, the outline Y is formed of one pair of flexure line portions Q and one pair of straight line portions S alternately connected, and each of the flexure line portions Q of the frame inner peripheral part and the vibrating member outer peripheral part includes a straight line and two curves of a predetermined curvature radius connected to both sides of the straight line, the flexure line portion Q of the frame inner peripheral part smoothly connects the straight line portions S thereof, the flexure line portion Q of the vibrating member outer peripheral part smoothly connects the straight line portions S thereof, and the center of curvature of two curves of the flexure line portion Q of the vibrating member outer peripheral part is located more inside than that of respective curves of the flexure line portion Q of the frame inner peripheral part.

In the sound emission surfaces shown in FIGS. 14A to 14D, as well as the flexure line portion Q, the straight line portion S may be formed of a flexure line, which is a combination of an arbitrary number of polygonal lines and an arbitrary number of curved lines.

Referring back to FIG. 4 again, the edge 114 is an annular elastic member including an edge outer peripheral part that is an outer peripheral part thereof and an edge inner peripheral part that is an inner peripheral part thereof. The edge outer peripheral part is fixed to the frame inner peripheral part, and the edge inner peripheral part is fixed to the vibrating member outer peripheral part. The edge 114 may be an elastic member having the edge outer peripheral part, an edge convex part, and the edge inner peripheral part.

The edge 114 may be an elastic member having the edge outer peripheral part, the edge convex part, the edge inner peripheral part, and an edge central part. The edge outer peripheral part has a cross section formed of a predetermined thickness. The edge convex part has a cross section that curves toward out-of-plane direction.

For example, the edge convex part may have a cross section formed of a predetermined thickness that curves toward a front side. The edge inner peripheral part may have a cross section formed of a predetermined thickness.

The edge central part may have a cross section formed of a predetermined thickness and may protrude outward surrounded by the edge inner peripheral part.

The sub frame 113a may be fixed to the main frame 113b in such a manner that the edge 114 is not fixed to the main frame 113b. The sub frame 113a may be fixed to the main frame 113b in such a manner that the edge 114 does not contact the main frame 113b.

The edge 114 may include a front edge 114a and a rear edge 114b. The front edge 114a may be an elastic member including a front edge outer peripheral part, a front edge convex part, and a front edge inner peripheral part.

In the front edge 114a, the front edge outer peripheral part is fixed to the front surface of the frame inner peripheral part, and the front edge inner peripheral part is fixed to the front surface of the vibrating member outer peripheral part. The rear edge 114b is an elastic member including a rear edge outer peripheral part, a rear edge convex part, and a rear edge inner peripheral part.

In the rear edge 114b, the rear edge outer peripheral part is fixed to the rear surface of the frame inner peripheral part, and the rear edge inner peripheral part is fixed to the rear surface of the vibrating member outer peripheral part.

The front edge convex part of the front edge 114a has a cross section formed of a predetermined thickness that curves toward the front side. The rear edge convex part of the rear edge 114b has a cross section formed of a predetermined thickness that curves toward a rear side.

The sub frame 113a may be fixed to the main frame 113b in such a manner that the front edge 114a and the rear edge 114b are not fixed to the main frame 113b. The sub frame 113a may be fixed to the main frame 113b in such a manner that the front edge 114a and the rear edge 114b do not contact the main frame 113b.

The actuator 112 is supported by the frame 113 and drives the vibrating member 111 to vibrate in the out-of-plane direction. The actuator 112 may be supported by the main frame 113b and drive the vibrating member 111 to vibrate in the out-of-plane direction.

The actuator 112 includes a voice coil bobbin (not shown), a voice coil (not shown), a yoke (not sown), a magnet (not shown), a pole piece (not shown), and an auxiliary magnet (not shown).

The voice coil bobbin is fixed to the vibrating member 111. For example, the voice coil bobbin is a tube-shaped member, one end of which is fixed to the vibrating member 111. For example, the voice coil bobbin may be a cylindrical shaped member, one end of which is fixed to the rear surface of the vibrating member 111. The voice coil is a wire wound around the voice coil bobbin.

The yoke is made of magnetic material and fixed to the main frame 113b. For example, the yoke is made of magnetic material and has a shape of a tube with a closed bottom. For example, the yoke is made of magnetic material and has a shape of a cylinder with a closed bottom. The magnet is fixed to the yoke.

For example, the magnet is in a shape of a pillar, one end of which is fixed to a bottom surface of the yoke. For example, the magnet is in a shape of a column, one end of which is fixed to a bottom surface of the yoke.

The pole piece is made of magnetic material and fixed to the magnet.

For example, the pole piece is a plate-like member made of magnetic material and fixed to the other end of the magnet. For example, the pole piece is a disk shaped member made of magnetic material and fixed to the other end of the magnet.

The gap between an outer periphery of the pole piece and an inner surface of the yoke forms a magnetic gap. The voice coil is positioned within the magnetic gap. The auxiliary magnet is fixed to the pole piece.

When an alternating voltage is applied to the voice coil, the voice coil bobbin receives an electro-magnetic force perpendicular to a vibrating surface of the vibrating member 111 and drives the vibrating member 111 to vibrate in the out-of-plane direction.

The cover frame 115 is a frame that covers a front side of the frame 113 and an outer peripheral part of the sub frame 113a. The cover frame 115 may cover the outer peripheral part and a side surface of the sub frame 113a, and may cover a front surface other than the frame opening part O and the side surface of the sub frame 113a.

The sub frame 113a may be lower in elastic modulus than the cover frame 115. For example, the sub frame 113a may be made of resin, and the cover frame 115 may be made of metal.

For example, the sub frame 113a and the main frame 113b may be made of resin, and the cover frame 115 may be made of metal.

For example, the sub frame 113a may be made of resin, and the main frame 113b and the cover frame 115 may be made of metal.

The cover frame 115, the sub frame 113a, and the main frame 113b may be fixed in such a manner that the front edge 114a and the rear edge 114b are not fixed to the main frame 113b and the cover frame 115.

The cover frame 115, the sub frame 113a, and the main frame 113b may be fixed in such a manner that the front edge 114a and the rear edge 114b do not contact the main frame 113b and the cover frame 115.

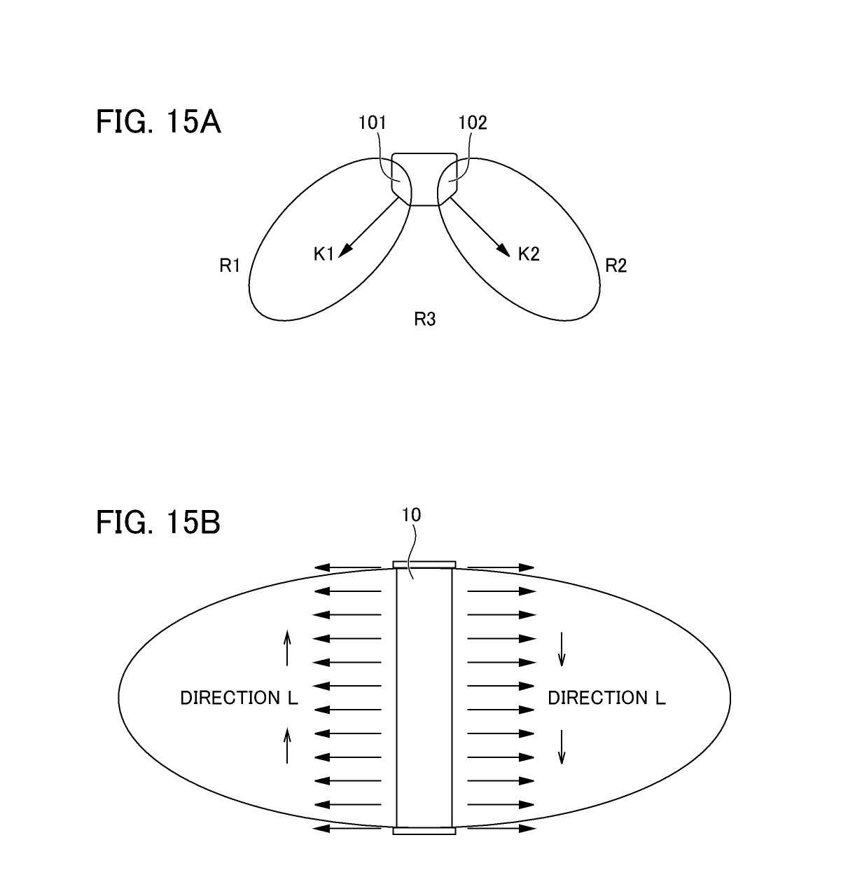

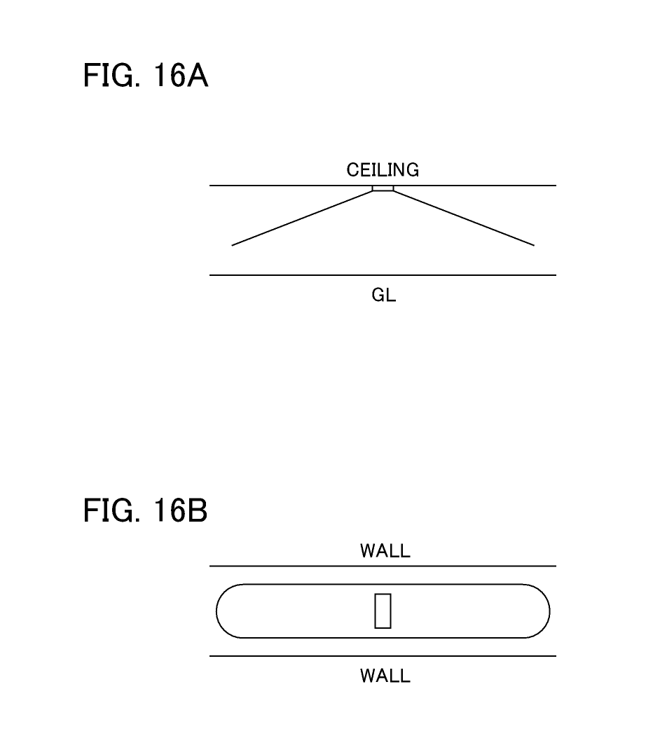

The following description is directed to the bidirectional directivity of the speaker system according to embodiments of the present invention. FIGS. 15 and 16 are diagrams explaining the bidirectional directivity of the speaker system according to embodiments of the present invention. The sound directivity shown in FIGS. 15 and 16 can be obtained by, for example, inputting two signals reverse in phase to each other from the signal input unit 300 to the speaker system according to the first to fourth embodiments of the present invention. Hereinafter, for ease of description, description will be given of a case in which the speaker system 10 according to the first embodiment is employed.

As shown in FIG. 15A, the sounds transmitted from the speaker system 10 including the first and second speaker units 101 and 102 is dominantly the sound emitted from the first speaker units 101 toward which the first speaker units 101 face, in the space region R1 along the first direction K1, and the sound emitted from the second speaker units 102 toward which the second speaker units 102 face, in the space region R2 along the second direction K2. On the other hand, in the narrow space region R3 (though exaggerated and shown wider in FIG. 15A for ease of understanding) along the imaginary line L between the first and second directions K1 and K2 in front of the first and second speaker units 101 and 102, the sounds emitted from the first and second speaker units 101 and 102 interfere with each other.

As a result thereof, the space region R3 is generated, where the sounds from the first and second speaker units 101 and 102 interfere with each other and sound components thereof reverse in phase to each other becomes inaudible. The space region R3 is adjustable by changing the angle between the first and second speaker units 101 and 102, as described earlier with reference to FIGS. 5 and 12. Therefore, it is possible to customize a most appropriate range of the space region R3 according to application.

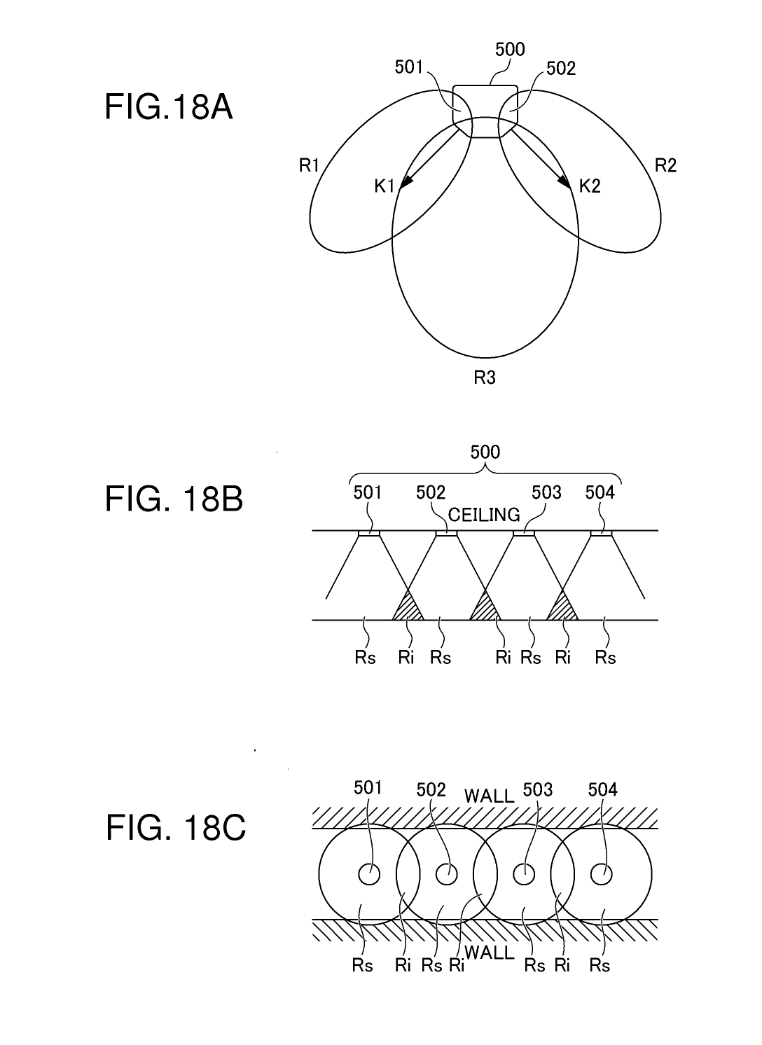

FIG. 16A is a side view of a propagation direction of the sound emitted from the speaker system 10, in a case in which the speaker system 10 is installed in a space such as a tunnel. Compared to the speaker system of prior art described earlier referring to FIG. 18B, in the speaker system 10 shown in FIG. 16A, a single speaker system 10 can cover a wide range. In the speaker system of prior art, if a speaker outputs a sound at a high volume so as to cover a wide range, the sound in an area immediately below the speaker becomes too loud. As a result thereof, it has been difficult for the speaker system of prior art to cover a wide range with a single speaker. On the other hand, in the speaker system 10 of the present embodiment, even if the speaker outputs a sound at a high volume, sounds emitted in an area immediately below the speaker system 10 cancel each other out, and almost vanish. As a result thereof, the sounds directly emitted from the speaker do not become too loud. Furthermore, in a case of a tunnel, sounds reflected from walls are audible in the area immediately below the speaker system 10, instead of the direct sounds. As a result thereof, it is possible to solve the problem of requiring a large number of speakers to cover a wide range. In the case of the prior art, the reflected sounds may cause problems since they interfere with sounds directly transmitted from the speaker. However, in the speaker system 10 of the present embodiment, the direct sounds emitted immediately below the speaker system 10, for example, in the region R3 shown in FIG. 15A vanish, and therefore, no longer interfere with the reflected sound, thereby making it possible to prevent the direct sounds from interfering with the reflected sounds in an unrestricted manner. Also, in the case of regions R1 and R2, since the direct sounds are larger in sound levels than the reflected sounds, thereby making it possible to prevent the reflected sounds from interfering with the direct sounds in an unrestricted manner as well.

Furthermore, as described earlier, in the speaker system 10 according to the first embodiment, since each speaker group has the elongated flat shaped sound emission surfaces arrayed in series, in a manner that they can be regarded as approximately one line sound source. FIG. 15B is a diagram showing cylindrical sound waves collectively emitted from the first and second speaker groups 11 and 12 as line sound sources, and propagating in a rectilinear manner in a direction perpendicular to the imaginary line L. The sound waves emitted from the speaker units arrayed in series overlap with one another, and propagate in a rectilinear manner while mainlining a wave surface in the form of a cylindrical shape (more particularly, a partially cylindrical shape) having each speaker group as a central axis thereof.

It has been described earlier with reference to FIGS. 18B and 18C, in the case of the speaker system of the prior art, which cannot control the directivity sufficiently, sounds are diffused in unrestricted manner, and reflected excessively from walls, thereby making the sounds unclear approximately everywhere.

On the other hand, FIG. 16B shows a top view of the sound directivity of the speaker system 10 according to the present embodiment installed in a similar space. In the speaker system of the present embodiment, since the sound wave emitted as a cylindrical sound wave propagates in a rectilinear manner, sounds are hardly diffused toward walls, and therefore, the sounds reflected from the walls rarely reach excessive level. As a result thereof, it is possible to solve the problem that sounds reflected excessively from walls make the sounds unclear.

Thus, according to embodiments of the present invention, it is possible to provide a speaker system having simple structure, high output power, and desired directivity.

It should be noted that the present disclosure is not limited to the embodiments described above, and any modifications thereto within the scope that can realize one or more of the objects of the disclosure are included in the disclosure.

For example, in the speaker system of the above described embodiments, various modified examples are possible by modifying the first and second inputs according to application.

In the above described embodiments, as the first and second inputs, signals derived from a common signal source but opposite in phase to each other (reverse phase signal and in-phase signal) have been employed. However, as the first and second inputs, respective signals that partially include the reversed phase signal and the in-phase signal may be employed.

For example, the reverse phase processing is performed on a signal (for example, a signal A) from one signal source to generate a reverse phase signal and a in-phase signal, and a signal (for example, a signal B) from the other signal source is composited as it is (without performing the reverse phase processing) with the reverse phase signal and the in-phase signal. Then, the resultant composite signal of the reverse phase signal and the signal B may be employed as the first input to be inputted to the first speaker group 11, and the resultant composite signal of the in-phase signal and the signal B may be employed as the second input to be inputted to the second speaker group 12. Among the first and second inputs, the reverse phase signal and in-phase signal, which are derived from the signal A, cancel each other out. Therefore, in a space where the sounds emitted from the first and second speaker groups 11 and 12 interfere with each other, for example, in the narrow space region R3 along the imaginary line L, the sound of the signal A is inaudible.

On the other hand, with regard to the signal B, sounds of both signals A and B are audible in the space regions R1 and R2, but only the sound of the signal B is audible in the space region R3, since the sounds of the reverse phase signal and the in-phase signal, which are derived from the signal A, cancel each other out.

FIG. 17 is a diagram explaining the bidirectional directivity of the speaker system according to the embodiments of the present invention in a case in which the first and second inputs partially include the reverse phase signal and the in-phase signal. Although any speaker system of the first to fourth embodiments is applicable, the speaker system 10 of the first embodiment will be described as an exemplification.

As shown in FIG. 17, the speaker system 10 includes the first speaker group 11 having the sound emission surface facing toward the first direction K1, and the second speaker group 12 having the sound emission surface facing toward the second direction K2.

The signal input unit 300 is provided with a phase reversal unit 301 for phase reversal, a first amplifier 302a and a second amplifier 302b for amplification.

The phase reversal unit 301 shifts a phase by 180 degrees of a signal A from a first signal source to constitute a part of a first input 1IN to the first speaker group 11, and outputs the resultant reverse phase signal to the first amplifier 302a.

The first amplifier 302a composites the reverse phase signal of the signal A from the first signal source, which has been reversed in phase by the phase reversal unit 301, with a signal B from a second signal source, and amplifies and outputs the composite signal as the first input 1IN to the first speaker group 11.

On the other hand, the second amplifier 302b composites the signal A (the in-phase signal) from the first signal source, which is not reversed in phase, and the signal B from the second signal source, and amplifies and outputs the composite signal as the second input 2IN to the second speaker group 12.

This means that, the reverse phase signal of the signal A from the first signal source and the signal B from the second signal source are inputted to the first speaker group 11, as the first input, while, the signal A (the in-phase signal) from the first signal source and the signal B from the second signal source, both of which are not reversed in phase, are inputted to the second speaker group 12, as the second input.

Therefore, as shown in FIG. 17, sounds transmitted from the speaker system 10 including the first and second speaker groups 11 and 12 include a sound dominantly emitted from the first speaker group 11 in the space region R1 along the first direction K1 toward which the first speaker group 11 faces, and a sound dominantly emitted from the second speaker group 12 in the space region R2 along the second direction K2 toward which the second speaker group 12 faces.

On the other hand, in the narrow space region R3 along the imaginary line L, i.e., in the space where the sounds respectively emitted from the first and second speaker groups 11 and 12 interfere with each other, among the sounds emitted from the first and second speaker groups 11 and 12, the respective sounds based on the reverse phase signal and in-phase signal of the signal A from the first signal source cancel each other out, while the sounds based on the signal B from the second signal source, which are identical in phase, overlap with each other and interfere constructively.

For example, a case is assumed that the speaker system 10 is installed along a road, employing, for example, a signal of a background music as the signal A from the first signal source and a signal of a message such as “five hundred meters to the next station” as the signal B from the second signal source.

In this case, the signal B of the message “five hundred meters to the next station” and the reverse phase signal of the signal A of the background music is inputted to the first speaker group 11 as the first input, and the signal B of the message “five hundred meters to the next station” and the in-phase signal of the signal A of the background music is inputted to the second speaker group 12 as the second input.

Therefore, a pedestrian walking in the space region R3 near the speaker system 10 can hear well the message “five hundred meters to the next station” and hardly hear the background music, since the sounds of the reverse phase signal and the in-phase signal cancel each other out.

On the other hand, a pedestrian away from the speaker system 10 can hear the background music as well as the message.

Therefore, the speaker system 10 can mute a sound from a part of the plurality of signal sources, while emitting a sound from the rest of the plurality of signal sources at a specific location, thereby making it possible to emit, for example, sounds representative of information merely important to pedestrians while muting other sounds derived from the rest of the signal sources at a specific location. It is evident that this effect is more advantageous if the background music from the first signal source is louder than the message from the second signal source.

On the contrary, in a case in which the message is required to be delivered merely to a pedestrian walking in the space regions R1 and R2, a signal of the message may be employed as the first signal source. Then, the message will be heard in the space regions R1 and R2, and hardly heard by a pedestrian walking in the space regions R3.

As another example, the signal source employed in the present embodiment is not limited to a signal indicative of a “meaningful sound” such as the above described background music, but an output signal from a noise cancelling device for cancelling a surrounding noise may be employed. For example, as a signal for cancelling a noise, a sound shifted in phase by 180 degrees from the collected surrounding noise may be employed. Especially, in a case in which particular noise is specified such as ambulance siren, tunnel noise, highway noise and/or the like, a signal for generating a sound shifted in phase by 180 degrees from the particular sound pattern thereof may be employed as a signal for cancelling the noise.

More specifically, a signal indicative of a sound shifted in phase by 180 degrees from a noise, i.e., a signal for cancelling the noise may be included in a signal B from the second signal source, which is not reversed in phase and to be inputted to the first and second speaker groups 11 and 12. Furthermore, according to the application of the speaker system, the signal for cancelling the noise may be included in a signal A from the first signal source, or, the signal for cancelling the noise may be included in both the signal A from the first signal source and the signal B from the second signal source.

As described above, according to the speaker system according to the embodiments of the present invention, it is possible to have the following effects.

Sounds corresponding to signals that are different from but associated with each other are respectively emitted from the first and second sound emission surfaces G1 and G2, having respective sound emission directions that intersect with each other at a predetermined angle. Therefore, the sounds that are different from but associated with each other interfere with each other, and it becomes possible to realize a speaker system having bidirectional directivity.

In a case in which the first and second inputs are signals derived from a common signal but opposite in phase to each other, no sound is audible in a space region where the sounds interfere with each other, and the sound is audible in a space region where the sounds do not interfere with each other.

Furthermore, one or more first speaker units 101 and one or more second speaker units 102 may be respectively arrayed in series along the imaginary line L perpendicular to the first and second directions K1 and K2. This configuration makes it possible for the sounds from the sound emission surfaces G to be overlapped and constructively interfered. While a sound emitted from a single speaker unit, which is a point sound source, spreads out as a spherical wave, a sound emitted from the plurality of speaker units arrayed in one or more lines along the imaginary line L as a line sound source spreads out as a cylindrical wave, which is more sharp in directivity and less in distance-dependent attenuation, compared to the sound from a point sound source. Thus, it is possible to transmit a high power sound over a long distance.

Furthermore, one or more first speaker units 101 and one or more second speaker units 102 may be respectively arrayed in series along the imaginary line L perpendicular to the first and second directions K1 and K2 so that long sides of the outlines of the vibrating members 111 are parallel to one another. This configuration makes it possible for the adjacent sound emission surfaces G to be placed close to each other, and the sounds from the sound emission surfaces G to be aligned in phase, efficiently overlapped, and constructively interfered.

Furthermore, one or more first speaker units 101 and one or more second speaker units 102 may be respectively arrayed in series along the imaginary line L perpendicular to the first and second directions K1 and K2 so that at least one pair of sides of the outline of each of the vibrating members 111 are parallel to at least one pair of sides of the outline of every other vibrating member 111. This configuration makes it possible for the adjacent sound emission surfaces G to be placed close to each other, and the sounds from the sound emission surfaces G to be aligned in phase, efficiently overlapped, and constructively interfered.

Furthermore, the central part of the first sound emission surface G1 may be positioned on the side of the first direction K1 from an intermediate position between the first and second sound emission surfaces G1 and G2, and the central part of the second sound emission surface G2 may be positioned on the side of the second direction K2 from an intermediate position between the first and second sound emission surfaces G1 and G2. This configuration makes it possible for sounds respectively emitted from the first and second sound emission surfaces G1 and G2 to efficiently interfere with each other in a space between the first and second directions K1 and K2.

Furthermore, the first end portion of the first sound emission surface G1 on the side of the second direction K2 and the second end portion of the second sound emission surface G2 on the side of the first direction K1 may be adjacent to each other. This configuration makes it possible for sounds respectively emitted from the first and second sound emission surfaces G1 and G2 to efficiently interfere with each other in the space between the first and second directions K1 and K2.

Furthermore, the first speaker units 101 and the second speaker units 102 may be arranged in such a manner to be staggered with each other along the imaginary line L. This configuration makes it possible for the sounds respectively emitted from the first and second sound emission surfaces G1 and G2 to efficiently interfere and overlap with each other.

Furthermore, the pluralities of first and second speaker units 101 and 102 may be respectively arrayed along the imaginary line L with a constant pitch. This configuration makes it possible for the sounds respectively emitted from the pluralities of first and second speaker units 101 and 102 to uniformly interfere and overlap with each other.

Furthermore, the intersection angle of the first and second directions K1 and K2 is between 45 and 135 degrees. Therefore, it becomes possible to acquire a directivity property in accordance with the intersection angle.

Furthermore, the intersection angle of the first and second directions K1 and K2 may be variable. This configuration makes it possible to change the directivity property in accordance with the intersection angle of the first and second directions K1 and K2.

Furthermore, in the first and second speaker units 101 and 102 arrayed in series along the imaginary line L perpendicular to the first and second directions K1 and K2, the speaker box 120 may form a rear space H enclosed on a rear side of the vibrating member 111 driven by the actuator 112. This configuration makes it possible for the sound emitted to the rear side of the vibrating member 111 to be confined in the rear space H, and the first and second speaker groups 11 and 12 to have stable acoustic properties.

Furthermore, in the first and second speaker units 101 and 102 arrayed in series along the imaginary line L perpendicular to the first and second directions K1 and K2, each speaker box 120 identical in form and dimension may form a rear space H enclosed on the rear side of the vibrating member 111 driven by the actuator 112. This configuration makes it possible for the sound emitted to the rear side of the vibrating member 111 to be confined in the rear space H identical in form and dimension, and for the first and second speaker groups 11 and 12 to have further stable acoustic properties.

Furthermore, in the first and second speaker units 101 and 102 arrayed in series along the imaginary line L perpendicular to the first and second directions K1 and K2, the speaker box 120 may support the vibrating member 111 driven by the actuator 112, and the vibrating members 111 may form the flat shaped sound emission surfaces G parallel to the imaginary line L. This configuration makes it possible for the first and second speaker groups 11 and 12 to have a stable sound directivity pattern.

Furthermore, in the first and second speaker units 101 and 102 arrayed in series along the imaginary line L perpendicular to the first and second directions K1 and K2, the speaker box 120 may form a sealed rear space H enclosed on the rear side of the vibrating member 111 driven by the actuator 112. This configuration makes it possible for the sound emitted to the rear side of the vibrating member 111 to be confined in the rear space H that is sealed, and for the first and second speaker groups 11 and 12 to have further stable acoustic properties.

The vibrating member 111 may be supported by the edge 114 so as to fit in the frame opening part, the actuator 112 supported by the frame 113 may drive the vibrating member 111, the outline of the vibrating member outer peripheral part may be formed of one pair of straight line portions S and one pair of flexure line portions Q alternately connected, the outline of the frame inner peripheral part may be formed of one pair of straight line portions S and one pair of flexure line portions Q alternately connected, and the gap between the respective flexure line portions Q of the vibrating member outer peripheral part and the frame inner peripheral part may be wider than the gap between the respective straight line portion S of the vibrating member outer peripheral part and the frame inner peripheral part. This configuration makes it easy for the edge 114 to have similar bending stiffness both along the straight line portions S and along the flexure line portions Q, which enables the vibrating member 111 to uniformly vibrate in the out-of-plane direction and the sound emission surface to emit a uniform sound to be precisely overlapped and reinforced.

Furthermore, according to one embodiment, the gap between the respective straight line portions S of the vibrating member outer peripheral part and the frame inner peripheral part is constant in width, and the gap between the respective flexure line portions Q of the vibrating member outer peripheral part and the frame inner peripheral part gradually becomes wider from the both ends respectively connected to the straight line portions S toward the middle thereof. According to this embodiment, it becomes easily possible for the edge 114 to have similar bending stiffness both along the straight line portions S and along the flexure line portions Q, which enables the vibrating member 111 to uniformly vibrate in the out-of-plane direction and the sound emission surface to emit a uniform sound to be precisely overlapped and reinforced.

Furthermore, according to one embodiment, since a center of curvature of the curved line of the vibrating member outer peripheral part is located more inside than that of the curved line of the frame inner peripheral part. Therefore, according to this embodiment, the gap between the respective flexure portions Q of the vibrating member outer peripheral part and the frame inner peripheral part gradually becomes wider from the both ends respectively connected to the straight line portions S toward the middle thereof. Furthermore, according to one embodiment, since the main frame 113b supports the actuator 112 and fixes the sub frame 113a formed of the frame opening part O, the edge 114 fixed to the sub frame 113a includes the front edge 114a and the rear edge 114b, the front edge 114a supports the front surface of the vibrating member 111, and the rear edge 114b supports the rear surface of the vibrating member 111. Therefore, according to this embodiment, it becomes possible to efficiently suppress tilt of the vibrating member 111 owing to tensile stiffness of the elastic member constituting the edge 114.

Furthermore, according to one embodiment, since the cover frame 115, which is higher in elastic modulus than the sub frame 113a, covers the outer peripheral part and the side surface of the sub frame 113a, it becomes possible to increase stiffness of the entire speaker 110, maintaining the supporting structure of the vibrating member 111 low in stiffness.

Furthermore, according to one embodiment, since the actuator 112 includes the voice coil bobbin, the voice coil, the yoke, the magnet, the pole piece, and the auxiliary magnet, and the voice coil receives a force perpendicular to the surface of the vibrating member 111 from the magnetic field, it becomes possible to suppress the vibrating member 111 from tilting.

While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A speaker system, comprising:
a first sound emission surface that emits a first sound in a first direction; and
a second sound emission surface that emits a second sound in a second direction that intersects with the first direction at a predetermined angle, wherein the first and second sounds include at least sounds respectively generated from a common first signal source and different in phase from each other.

2. The speaker system according to claim 1, wherein
the sounds respectively generated from the common first signal source are shifted in phase by 180 degrees from each other.

3. The speaker system according to claim 1, wherein
the first and second sounds include at least sounds respectively generated from a common second signal source and identical in phase to each other.

4. The speaker system according to claim 1, further comprising a third sound emission surface that emits a third sound in a third direction that intersects with the first and second directions respectively at predetermined angles, wherein
the third sound includes at least a sound generated from the common first signal source.

5. The speaker system according to claim 3, wherein
the first and second sounds include a sound, which is generated from the second signal source and shifted in phase by 180 degrees from noise.

6. The speaker system according to claim 1, wherein
the speaker system is configured by:
a first speaker group including a plurality of speaker units having the first sound emission surface; and
a second speaker group including a plurality of speaker units having the second sound emission surface.

7. The speaker system according to claim 6, wherein:
the first speaker group includes a plurality of first speaker units arrayed in one or more lines along a direction perpendicular to the first and second directions, and
the second speaker group includes a plurality of second speaker units arrayed in one or more lines along a direction perpendicular to the first and second directions.

8. The speaker system according to claim 7, wherein:
each speaker unit of the first and second speaker groups includes a speaker and a speaker box that supports the speaker,
the speaker includes:
a vibrating member formed with the first sound emission surface or the second sound emission surface on a front surface thereof; and
an actuator that drives the vibrating member, wherein
the vibrating member is formed with the first sound emission surface or the second sound emission surface of an elongated outline, wherein
the plurality of speaker units of the first speaker group are arranged in such a manner that longitudinal directions of the outlines thereof are parallel to one another and the first sound emission surfaces thereof form the same plane, and wherein
the plurality of speaker units of the second speaker group are arranged in such a manner that longitudinal directions of the outlines thereof are parallel to one another and the second sound emission surfaces thereof form the same plane.

9. The speaker system according to claim 7, wherein:
each speaker unit of the first and second speaker groups includes a speaker and a speaker box that supports the speaker,
the speaker includes a vibrating member having the first sound emission surface or the second sound emission surface on a front surface thereof and an actuator that drives the vibrating member,
the vibrating member includes the first sound emission surface or the second sound emission surface having an outline including at least one pair of parallel sides, wherein,
in the first speaker group, the plurality of speaker units are arranged in such a manner that the at least one pair of parallel sides of the outline of each vibrating member are parallel to the at least one pair of parallel sides of the outline of every other vibrating member, and
the first sound emission surfaces thereof form the same plane, and in the second speaker group, the plurality of speaker units are arranged in such a manner that the at least one pair of parallel sides of the outline of each vibrating member are parallel to the at least one pair of parallel sides of the outline of every other vibrating member, and the second sound emission surfaces thereof form the same plane.

10. The speaker system according to claim 1, wherein
in the speaker system, viewed from a direction that bisects the angle formed between the first and second directions, a central part of the first sound emission surface is positioned on a side of the first direction from an intermediate position between the first and second sound emission surfaces, and a central part of the second sound emission surface is positioned on a side of the second direction from an intermediate position between the first and second sound emission surfaces.

11. The speaker system according to claim 8, wherein
in the speaker system, viewed from a direction that bisects the angle formed between the first and second directions, a first end portion, which is defined as an end portion of the outline of the first sound emission surface on a side of the second sound emission surface, and a second end portion, which is defined as an end portion of the outline of the second sound emission surface on a side of the first sound emission surface, are adjacent to each other.

12. The speaker system according to claim 7, wherein
the first speaker units arrayed in one or more lines and the second speaker units arrayed in one or more lines are arranged in staggered relation to each other.

13. The speaker system according to claim 7, wherein
the first speaker units arrayed in one or more lines and the second speaker units arrayed in one or more lines are arranged equidistantly with a constant pitch.

14. The speaker system according to claim 1, wherein
the intersection angle of the first and second directions is in a range between 45 and 135 degrees.

15. The speaker system according to claim 1, wherein
the intersection angle of the first and second directions is variable.
